(19) United States
(12) Patent Application Publication
(10) Pub. No.: US 2009/0283982 A1
(43) Pub. Date: Nov. 19, 2009

(54) USER-PROPELLED WHEELED VEHICLES

(75) Inventor: Enda Thomas, Enfield (GB)

Correspondence Address: K&L Gates LLP, STATE STREET FINANCIAL CENTER, One Lincoln Street, BOSTON, MA, 02111-2950, US

(73) Assignee: Michael Burke

(21) Appl. No.: 12/298,964

(22) PCT Filed: Apr. 27, 2007
(86) PCT No.: PCT/GB2007/001559

§ 371 Date: Jul. 29, 2009

Related U.S. Application Data
(60) Provisional application No. 60/860,815, filed on Nov. 24, 2006.

(30) Foreign Application Priority Data
Apr. 29, 2006 (GB) 0608547.6
Aug. 21, 2006 (GB) 0616529.4
Oct. 20, 2006 (GB) 0620886.2
Feb. 12, 2007 (GB) 0702636.2
Feb. 12, 2007 (GB) 0702637.0
Feb. 12, 2007 (GB) 0702638.8

(51) Int. Cl. B62M 1/00; B62M 1/04; G05G 1/08

(52) U.S. Cl. 280/234; 280/241; 74/507

(57) ABSTRACT

A seated user-propelled vehicle (500) can be propelled using levers (1000) acting on the rear side wheels (595). The levers are disposed between the wheels and the sides (530, 532) of the vehicle and can be moved together, separately or in turn. The levers have curved drive ends (113), the faces of which include a length of roller chain (127) to mesh with freewheels (555) on the hubs of the wheel axles (560) and are held in sufficient co-operation against the freewheels due to tensioning. The levers can be raised through approximately 90° in each drive stroke. Smooth and effective propulsion is obtained. Other uses of the drive levers are disclosed, including a go-kart, power generator, watercraft and personal exercise machine.

### TECHNICAL FIELD

The present invention relates to improvements in user-propelled wheeled vehicles. User-propelled means throughout the specification propelled by an occupant of the vehicle.

### BACKGROUND OF THE INVENTION

The Applicant has filed International patent application no. PCT/GB 2005/000111 for user-propelled wheeled vehicles. Disclosed therein are user-propelled wheeled vehicles in the form of a scooter and a wheelchair having in front a drive mechanism comprising a central front wheel and a combined steering column and push forward-pull back lever device, for turning the front wheel forwards, thereby propelling the vehicle forwards. The steering column assembly is attached to the scooter and to the wheelchair via an arrangement extending upwardly from the front of the wheelchair. This arrangement depends on the ability of the user to pull the steering column and on the reliability of the attachment between the drive mechanism and the rest of the vehicle.

Also other vehicles are known having unwieldy mechanisms with which the user can drive the wheels forwards. Such mechanisms are likely to be unreliable. It is known to self-propel wheelchairs using the rims of large rear wheels or external rings attached thereto but in these instances, the wheelchair is difficult to move along fast as it is difficult for the user to move their own weight along while seated next to the driven wheels.

It is an object of the present invention to provide improved user-propelled wheeled vehicles.

According to a first aspect of the invention, I propose a user-propelled wheeled vehicle having a seat for a user, comprising propelling apparatus comprising a driven wheel on each side of the vehicle and a device for driving each wheel, each drive device comprising a rigid lever, which is angularly movable about a transverse pivot axis at the side of the vehicle;

the lever having a user-operable portion on one side of the pivot axis and a drive end on the other side of the pivot axis, wherein the drive end is arcuately-reciprocatable with the user-operable portion and wherein the drive end includes a curved drive face, which includes a linear device for driving engagement with a sprocket wheel, which is co-axially mounted, between the wheel and the vehicle, on the hub of the wheel axle of the respective adjacent wheel, to drivingly co-operate with the respective vehicle wheel, to angularly move the wheel forwards and thereby to propel the vehicle forwards.

Accordingly, direct drive on the side wheels may be obtained by a user pushing the arm levers forwards and they may propel themselves along effectively by repeated use of the levers. A seated user may propel themselves along by turning the wheels by hand if required. In one form the vehicle may be a wheelchair. In other forms the vehicle may be a play or sports vehicle.

The sprocket may be a freewheel gear. The linear engaging device may be a length of bicycle-type chain. The driven wheels may be at the rear of the sides of the vehicle.

In one embodiment the drive lever has a maximum angle of movement of approximately 90°.

A tensioning device may be provided at both ends of the linear wheel-engaging device to hold the wheel-engaging device and the sprocket in sufficient engagement for driving the wheel. The linear engaging device may extend round the edge of at least one of the ends of the curved drive portion. The tensioning devices may be disposed so as to act in generally opposing directions. The tensioning devices may comprise a screw at one end of the engaging device and a screw at the other end, opposing one another, whereby the length of the engaging device is adjustable. The vehicle according may further include an additional tension spring at one end of the engaging device.

According to a second aspect of the invention, we propose a user-propelled wheeled vehicle having a support for a user, a wheel on each side of the vehicle, a device for steering the vehicle, and apparatus for driving at least one of the side wheels, the apparatus comprising a rigid lever, which is angularly movable about a pivot axis at the side of the vehicle,

the lever having a user-operable portion on one side of the pivot axis and a drive end on the other side of the pivot axis, wherein the drive end is arcuately-reciprocatable by the user-operable portion and includes a curved drive face, which includes a linear device for driving engagement with a device, which is co-axially mounted, between the wheel and the vehicle, on the hub of the wheel axle of the respective adjacent wheel, to angularly move the wheel forwards and thereby to propel the vehicle forwards.

Accordingly, direct drive on the at least one wheel may be obtained by a person, who is wholly supported on the vehicle, pushing the at least one lever forwards. If there is more than one lever, for example one on each side of the vehicle, they may be moved at the same time or separately or in turn as desired. If there is only one lever or only one is used, a brake may be used on the other side of the vehicle as a steering device or an alternative steering device may be employed. Furthermore, a plurality of steering devices may also be used with a plurality of drive levers. The user support may be adjacent the side wheels. The user support may be disposed between the side wheels. The pivot axis may be transverse as defined herein.

Thus, the person may propel themselves along effectively by repeated use of the at least one lever and travel may be obtained. Smooth forward propulsion of the vehicle may be obtained and moreover, the vehicle can be continuously propelled forwards over considerable distances. It has been found that not only can vehicles according to the invention be run forward effectively in an unexpectedly highly smooth lever action, and they can be used to travel long distances if required, but also they unexpectedly are also highly maneuverable. Vehicles according to the invention do not need a steering column or handlebar column at the front, which may be difficult for the user to reach from a seat on the vehicle. The at least one driven side wheel may be at the rear of the vehicle.

The user support may be adjacent the at least one driven wheel. The user support may be disposed between the side wheels of the vehicle. In one form, the user may be supported, for instance, in a sitting position, for example on the seat of a wheelchair or of a golf buggy, or in another form, they may be supported in a cart or similar with open or raised sides as well as a support base. Other forms are possible, such as with supports for persons without legs or supports for persons in a standing position. Vehicles according to the invention can move the weight of a supported person along in a smooth and effective manner.

The user-operable arm may be a generally straight elongate member; the ratio of the length of the user-operable arm to the length of the radial member may be approximately 3:1.

The lever pivot axis may be parallel with the pivot axis of the vehicle wheel. The lever pivot axis may be disposed forwardly of the wheel pivot axis. The lever pivot axis may be disposed upwardly of the wheel pivot axis. The drive lever may be supported for movement between a lowered generally horizontal position and a raised generally upright position. The drive lever may have a maximum angle of movement of approximately 90°. This may be more than 90°.

The lever may be pivotally mounted on a rigid support at the side of the vehicle. The wheel may also be pivotally mounted on this rigid support. The support may be planar. At least one side edge of the support may be attached to the vehicle. The planar support may be an elongate brace.

The lower drive end of the drive lever may further include an integral radial member connecting the curved drive end to the user-operable portion, the radial member inclined outwardly away from the upper portion. The distance between the wheel axis and the lever axis may be generally the same as the length of the radial member plus the radius of the co-axial device on the wheel hub. The radial member is angularly movable through the same angle as the upper arm of the drive lever.

The co-axial device may include an arcuate circumferential portion for engaging with the drive face; the arcuate portion may be disposed between the pivot axis of the lever and the pivot axis of the driven wheel. The co-axial device may be a sprocket wheel and the linear device may be a roller chain, which may be bicycle-like. In embodiments of the invention the roller chain may co-operate with the teeth of the sprocket on the wheel hub, with each roller fitting in the space between each pair of adjacent sprocket teeth.

The lever may be disposed to co-operate with the sprocket wheel at one side of the sprocket wheel. The lever may co-operate with the sprocket wheel in one quadrant i.e. one quarter of the circumference of the sprocket wheel. The quadrant may be an upper quarter of the circumference of the sprocket wheel.

A tensioning device may be included at both ends of the linear device for tensioning the linear device so as to hold it in sufficient co-operation with the respective driven wheel for driving the wheel. This greatly assists in the smooth lever drive action. The tensioning device may comprise a screw at one end of the engaging device and a screw at the other end, for tightening the chain, whereby the length of the chain is adjustable. A tension spring may be added at one end of the engaging device.

The combination of the arrangement of the lever inwardly of the wheel, the maximum angle of movement of the drive lever and the tensioned linear engaging device on the lever drive end results in surprisingly smooth and effective transmission of power from the lever to the driven wheel.

The vehicle may include a brake for at least one respective driven wheel. The steering apparatus may be provided by the at least one brake. It has been found that this assists in the high maneuverability of the vehicle. The at least one brake may be progressive for additional control. The at least one brake may be a hydraulic disc brake as it requires minimal pressure for activation. Hydraulic brakes are also sufficiently gentle and sensitive to assist with balancing the vehicle during propulsion, in particular on slopes. By applying a gentle force to the brake on the opposite side to a downward slope and operating the lever on the side of the slope, the vehicle can continue in a straight line.

In one arrangement, the sprocket wheel may be disposed between the brake disc and the respective driven wheel. In another arrangement, the brake disc may be disposed between the sprocket wheel and the respective driven wheel.

The vehicle may be a human-powered wheelchair or a human-powered go-kart. A balancing device may be provided forwardly of the side wheels. This may be provided by further wheels. The balancing apparatus may be steerable and the aforementioned steering apparatus may be provided by the balancing apparatus. In one form the balancing apparatus may be a device mounted on a shaft extending forwardly of the seat. The balancing device may be a wheel mounted centrally with respect to the rear wheels.

The vehicle may further comprise a rigid transverse member receiving the outer end of the support shaft, wherein a pivot is provided by a device disposed through both the shaft and the rigid transverse member, for sideways steering of the vehicle.

The vehicle may further comprise a pair of spaced, rigid, side arms connecting:

firstly, at their lower ends, footrests, for steering, on the balancing device, with
secondly, at their upper ends, the rigid transverse member.

The rigid transverse member may include a pair of spaced upper and lower walls and the outer end of the support shaft may be held in the space therebetween, and the support shaft pivot device may be disposed through the upper and lower walls as well as through the shaft therebetween. The rigid transverse member may further comprise a vertical wall, disposed forwardly of the support shaft.

Also, each of the ends of the curved drive face may be rounded so that the drive face may easily run on and off the co-axial device of the or each respective driven wheel, so that the rim of the wheel can then be moved manually. Hence a supported user may alternatively propel themselves along by turning the wheels by hand if required. The drive lever apparatus and vehicles therewith according to the invention are usually intended for forward travel, so once the drive face is off the sprocket wheel, the vehicle may be reversed by hand or even moved forwards or turned a small distance, as desired.

According to another aspect of the invention we also propose drive lever apparatus for user-propelled wheeled vehicles having a support for a user and a wheel on each side of the vehicle, the apparatus comprising

at least one drive lever device for driving one of the side wheels, the or each at least one drive device comprising a rigid lever, which in use is angularly movable about a pivot axis at the side of the vehicle, the lever having a user-operable portion on one side of the pivot axis and a drive end on the other side of the pivot axis, the drive end including a curved drive face, for drivingly co-operating with the respective vehicle wheel,

a device to be mounted co-axially on the respective driven wheel for angular movement therewith,

a linear device on the curved drive face of the drive lever, the co-axial device being capable of engaging with the linear device such that the linear device can drivingly engage the co-axial device, so as to turn the respective driven wheel of the vehicle.

The ratio of the length of the user-operable arm to the length of the radial member may be approximately 3:1.

The drive lever apparatus may further include a rigid support for attaching the lever at its fulcrum on the side of the vehicle. The rigid support may also include an attachment location for the respective driven wheel. The support may be planar. At least one side edge of the support may be suitable for attachment to the vehicle. The support may also act as a brace.

The co-axial device may include an arcuate circumferential portion for engaging with the drive face and in use the arcuate portion may be disposed between the pivot axis of the lever and the pivot axis of the driven wheel. The co-axial device may be a sprocket wheel and the linear device may be a roller chain. The drive lever apparatus may further include a tensioning device at both ends of the linear device for tensioning the linear device so as to hold it in sufficient co-operation with the at least one respective driven wheel for driving the wheel.

The drive lever apparatus may further include an independent brake for at least one respective driven wheel. The at least one brake may be progressive. The at least one brake may be a hydraulic disc brake.

The drive lever apparatus according to the invention may be a conversion kit for vehicles having at least one driven wheel. It may be provided as a conversion kit for conventional wheelchairs.

We therefore provide in accordance with a further aspect of the invention a seated user-propelled wheeled vehicle comprising propelling apparatus comprising a driven wheel on each side of the vehicle and a device for driving each wheel, each drive device comprising a rigid lever, which is angularly movable about a transverse pivot axis at the side of the vehicle;

the lever having a user-operable portion on one side of the pivot axis and a drive end on the other side of the pivot axis, the drive end including a curved drive face, which drivingly co-operates with the wheel, wherein the drive end is arcuately-reciprocatable with the user-operable portion to angularly move the wheel forwards and thereby to propel the vehicle forwards.

Further features which may be included in any of the above aspects of the invention are as follows:

The lever may comprise one or more rigid portions joined together.

The driven wheels may be at or towards the rear of the sides of the vehicle.

The vehicle frame and the drive lever may be made from suitable lightweight, strong, rigid material, such as aluminium alloy, titanium or carbon fibre.

User-propelled vehicles according to the above aspects of the invention may be readily assembled and can be used to provide an effective, lightweight individual means of transport.

It should be noted that throughout this specification the term “transverse” means extending across the vehicle and “transverse” should be taken to include perpendicular to a longitudinal centre line through the front and rear ends of the vehicle, but may also include variation from the perpendicular, provided that the vehicle may move forwards. Also, throughout this specification the term “arcuately-reciprocatable” means angularly movable repeatedly to-and-fro about a pivot.

User-propelled vehicles according to any of the above aspects of the invention may also be referred to by the term velocipede. Vehicles according to the invention with at least one pair of driven wheels, one on each side of the user support in the or each pair, and with at least one pair of levers, one on each side of the user support, may be propelled in a “Nordic Skiing” type of arm action, by alternately moving the lever arms repeatedly. This allows highly effective control of the vehicle and also assists with stability. Such vehicles can move the weight of a supported person along in a smooth and effective manner.

One use of vehicles according to this aspect of the invention may be for the transport of disabled or infirm persons. Other uses of the vehicle may be recreational, for example a children's play vehicle, or a sports vehicle, for example for racing. Other human-powered vehicles may employ the lever assembly of the invention. For instance vehicles may take the form of a wheeled cart with open or closed sides and ends. In other forms of the invention the lever assembly may be mounted at or towards the front of the sides of the vehicle.

We also propose other aspects of the invention using drive lever apparatus:

One further such aspect of the present invention relates to improvements in apparatus for producing power.

Renewable energy is an important form of energy, with energy resources becoming globally both more scarce and more in demand. The personal creation of renewable energy is becoming more widespread, for example deploying wind turbines where they live.

It is an object of this aspect of the invention to provide a source of power harnessing renewable energy.

According to a fourth aspect of the invention we propose apparatus for generating power, comprising at least one rigid lever mounted on the apparatus so that in use the at least one lever is angularly movable about a pivot axis;

the lever having a user-operable portion on one side of the pivot axis and a drive end on the other side of the pivot axis, the drive end including a curved drive face, for drivingly co-operating with a gearwheel which is drivingly connected with a device for producing power, wherein the drive end of the lever is arcuately-reciprocatable about the same pivot axis as the user-operable portion by and with the user-operable portion to angularly move the gearwheel for producing power.

Accordingly, direct drive on the gearwheel may be obtained by a user angularly moving the lever repeatedly to-and-fro. A plurality of levers may be employed according to the invention: they may be moved at the same time or separately or in turn as desired. The pivot axis may be transverse as defined below. The apparatus may be called a human-powered energy generator.

Throughout this specification the term “arcuately-reciprocatable” means angularly movable repeatedly to-and-fro about a pivot.

The device for producing power may be an electrical alternator. The driven gearwheel may be connected with the alternator via a transmission shaft.

It has been found that apparatus according to this aspect of the invention may be used to generate approximately 1.5 Kw. Hence, apparatus according to the invention may for example provide power for portable devices such as:

small generators,

small televisions,

audio devices for example a radio, or personal stereo,

electrical lighting devices for example a torch, a lamp, or an emergency light,

battery-powering devices for example a phone charger, a rechargeable battery pack, or electrical shaver,

low voltage electrical household appliances for example a blender, or an electric toothbrush.

In one form of the apparatus, the apparatus may be adapted to provide energy for a portable electrical device and the lever and the gearwheel may be provided on a rigid support, for example the outer casing of the electrical device, with the lever adjacent the driven gearwheel for co-operation therewith.

In another form, the apparatus may be suitable for the production of electrical power by a person supported on the apparatus, the lever being arcuately-reciprocatable by the person so as to directly drive the driven gearwheel. In particular, a user support may be disposed between a pair of drive levers and respective gearwheels. In one form, the user support may be a seat so that a user may be supported on a seat in a sitting position, whereby the seated user may produce power by moving the at least one lever to-and-fro while seated. Apparatus according to this aspect of the invention, for example in this form, may, for instance, be used to provide electrical power to supplement personal vehicles. More particularly, apparatus according to this aspect of the invention may be used to supplement human-powered wheeled vehicles, particularly as disclosed in the Applicant's earlier patent applications, from which priority is here claimed, GB 0616529.4 and GB 0620886.2. and for example as described elsewhere in this specification.

In a seated embodiment, the lever pivot axis may be parallel with the pivot axis of the first gearwheel. The lever pivot axis may be disposed forwardly (as viewed by a supported user) of the wheel pivot axis. The lever pivot axis may be disposed upwardly of the wheel pivot axis.

A secondary transmission device to change the direction of the output from the primary transmission shaft may be provided. The primary transmission shaft or axle may be disposed between two driven gearwheels and the secondary transmission device may comprise a second gearwheel mounted on the axle for movement therewith, an endless looped transmission drive, for example a belt or chain, connecting the gearwheel on the axle with a third gearwheel connected with an alternator to produce electricity.

The drive lever apparatus may further include a linear device on the curved drive face of the drive lever to mesh with the gearwheel.

This co-operation unexpectedly results in highly smooth and effective transmission of energy from the lever to the driven gearwheel. The linear device may be a roller chain, which may be bicycle-like.

The driven gearwheel may be a freewheel sprocket and the lever may be disposed to co-operate with the sprocket wheel at one side of the sprocket wheel. The lever may co-operate with the sprocket wheel in one quadrant i.e. one quarter of the circumference of the sprocket wheel. The quadrant may be an upper quarter of the circumference of the sprocket wheel.

A tensioning device may be included on the linear device for tensioning the linear device so as to hold it in sufficient co-operation with the respective driven wheel for driving the wheel. This greatly assists in the smooth lever drive action. A tensioning device may be provided at both ends of the linear device.

In embodiments according to this aspect of the invention the roller chain may co-operate with the teeth of the gearwheel, such that each roller fits in the space between each pair of adjacent sprocket teeth.

A tensioning device may be provided at both ends of the linear meshing device to hold it in sufficient co-operation with the gearwheel for driving the gearwheel. The tensioning device may comprise a screw at either or both ends of the linear meshing device for tightening the chain, whereby the length of the chain is adjustable. A tension spring may be added at one end of the engaging device.

Further features which may be included are as follows:

The lever may comprise one or more rigid portions joined together. The frame and the drive lever may be made from suitable lightweight, strong, rigid material, such as aluminium alloy, titanium or carbon fibre.

The above apparatus may be readily assembled and can be used to provide an effective, lightweight means of producing power.

It should be noted that the term “transverse” means extending across the framework of the apparatus and “transverse” should be taken to include perpendicular to a longitudinal centre line through the front and rear ends of the framework, but may also include variation from the perpendicular.

Apparatus according to this aspect of the invention with at least one pair of levers, one on each side of the user support, may be propelled in a “Nordic Skiing” type of arm action, by alternately moving the lever arms repeatedly. This allows highly effective movement of the drive levers and also assists with stability of the apparatus.

Another aspect of the invention relates to improvements in watercraft.

Renewable energy has become an important form of energy, with energy resources becoming more scarce and more in demand. The personal creation of renewable energy is becoming more widespread, for example deploying wind turbines where they live.

It is an object of this aspect of the invention to provide a watercraft employing renewable energy.

According to a fifth aspect of the invention we propose a watercraft, comprising at least one rigid lever mounted on the craft so that the lever is angularly movable about a pivot axis;

the at least one lever having a user-operable portion on one side of the pivot axis and a drive end on the other side of the pivot axis, the drive end including a curved drive face, for drivingly co-operating with a gearwheel connected with a device for propelling the craft through water, wherein the drive end is arcuately-reciprocatable about the same pivot axis as the user-operable portion by and with the user-operable portion, to angularly move the gearwheel and thereby to propel the water craft along in water.

Accordingly, direct drive on the at least one gearwheel may be obtained by a user angularly moving the lever to-and-fro. A plurality of levers may be employed according to this aspect of the invention: they may be moved at the same time or separately or in turn as desired. A pair of spaced-apart levers may be employed, one lever on each side of the craft.

Throughout the term “arcuately-reciprocatable” means angularly movable repeatedly to-and-fro about a pivot.

The pivot axes may be transverse as defined below. The pivot axis of the lever may be parallel with the pivot axis of the gearwheel. The lever pivot axis may be disposed forwardly and upwardly (as viewed by a person in and facing the front of the watercraft) of the wheel pivot axis.

In one form of the watercraft, wherein the at least one propulsion device may be connected with an axle mounted on the side of the watercraft and the gearwheel of the respective lever may be disposed on a respective axle, whereby the propulsion device is directly turned by the respective lever.

With a plurality of levers, the outputs of the levers may be separate in order that they may be used for steering the watercraft.

Another form of the watercraft comprises a propulsion device mounted at the back of the watercraft, a secondary shaft connected with the propulsion device at the back of the watercraft, and a secondary transmission device to change the direction of the output from the gearwheels of the levers to drivingly connect the outputs to the propulsion device.

The gearwheels may be mounted on a primary transmission shaft disposed transversely across the craft. A 90° gearbox may be disposed on the primary shaft to drivingly connect the primary shaft to a secondary shaft connected with the propulsion device at the back of the watercraft.

In the case of gearwheels driven by a respective lever at each side of the watercraft and mounted on the same output shaft, the gearwheels must be capable of both rotating the shaft in the same direction.

The drive lever apparatus may further include a linear device on the curved drive face of the drive lever to mesh with the gearwheel. The linear device may be a roller chain, which may be bicycle-like. With the length of roller chain, there is an unexpectedly highly smooth and effective transmission of power from the lever to the driven gearwheel. In embodiments according to the invention the roller chain may co-operate with the teeth of the gearwheel, such that each roller fits in the space between each pair of adjacent sprocket teeth.

The driven gearwheel may be a freewheel sprocket and the lever may be disposed to co-operate with the sprocket wheel at one side of the sprocket wheel. The lever may co-operate with the sprocket wheel in one quadrant i.e. one quarter of the circumference of the sprocket wheel. The quadrant may be an upper quarter of the circumference of the sprocket wheel.

A tensioning device may be included on the linear device for tensioning the linear device so as to hold it in sufficient co-operation with the respective driven wheel for driving the wheel. This greatly assists in the smooth lever drive action.

A tensioning device may be provided at both ends of the linear meshing device to hold it in sufficient co-operation with the gearwheel for driving the gearwheel. The tensioning device may comprise a screw at either or both ends of the linear meshing device for tightening the chain, whereby the length of the chain is adjustable. A tension spring may be added at one end of the engaging device.

Further features which may be included are as follows:

The lever may comprise one or more rigid portions joined together.

The levers may be at or towards the rear of the sides of the watercraft.

The at least one drive lever may be made from suitable lightweight, strong, rigid material, such as aluminium alloy, titanium or carbon fibre.

It should be noted that throughout the term “transverse” means extending across the watercraft and “transverse” should be taken to include perpendicular to a longitudinal centre line through the front and rear ends of the framework, but may also include variation from the perpendicular.

A watercraft according to this aspect of the invention with at least one pair of levers, one on each side of the user support, may be propelled in a “Nordic Skiing” type of arm action, by alternately moving the lever arms repeatedly. This allows highly effective propulsion of the craft and also assists with stability.

Another aspect of the invention relates to personal exercise machines. Renewable energy has become an important form of energy, with energy resources becoming more scarce and more in demand. The personal creation of renewable energy is becoming more widespread, for example deploying wind turbines where they live.

According to a sixth aspect of the invention we propose a personal exercise machine, comprising an endless path device and at least one rigid lever mounted on the exercise machine so that the lever is angularly movable about a pivot axis;

the at least one lever having a user-operable portion on one side of the pivot axis and a drive end on the other side of the pivot axis, the drive end including a curved drive face, for drivingly co-operating with a gearwheel drivingly connected with the endless path device, wherein the drive end is arcuately-reciprocatable about the same pivot axis as the user-operable portion by and with the user-operable portion, to angularly move the gearwheel and thereby to operate the exercise machine.

Thus, direct drive on the at least one gearwheel may be obtained by a user angularly moving the lever to-and-fro, in order that an endless path device may be moved by the person exercising on a stationary exercise machine. A plurality of levers may be employed according to this aspect of the invention: they may be moved at the same time or separately or in turn as desired. A pair of spaced-apart levers may be employed, angularly-movable by a person's hands or arms.

Throughout the term “arcuately-reciprocatable” means angularly movable repeatedly to-and-fro about a pivot.

The pivot axes may be transverse as defined below. The pivot axis of the lever may be parallel with the pivot axis of the gearwheel. The lever pivot axis may be disposed forwardly and upwardly (as viewed by a person in and facing the front of the watercraft) of the wheel pivot axis.

The endless path device may be an endless belt or track. One form of the personal exercise machine according to the invention may be a treadmill, the endless path device being a belt or track operated by the lever.

The at least one gearwheel may be drivingly connected with a driven wheel, which is itself drivingly connected with the endless path device for operation.

The at least one gearwheel may be drivingly connected with a transmission shaft or axle, drivingly connected with the endless path device for operation. The transmission shaft may be transversely disposed.

The transmission shaft may be drivingly connected with a treadmill belt, for example one end of the belt may be mounted around the transmission shaft and the other end of the belt may be mounted on a non-driven shaft, whereby the belt is movable by the shaft in an endless loop around the two shafts.

In the case of gearwheels driven by a respective lever at each side of the watercraft and mounted on the same output shaft, the gearwheels must be capable of both rotating the shaft in the same direction.

The drive lever apparatus may further include a linear device on the curved drive face of the drive lever to mesh with the gearwheel. The linear device may be a roller chain, which may be bicycle-like. With the length of roller chain, there is an unexpectedly highly smooth and effective transmission of power from the lever to the driven gearwheel. In embodiments according to the invention the roller chain may co-operate with the teeth of the gearwheel, such that each roller fits in the space between each pair of adjacent sprocket teeth.

The driven gearwheel may be a freewheel sprocket and the lever may be disposed to co-operate with the sprocket wheel at one side of the sprocket wheel. The lever may co-operate with the sprocket wheel in one quadrant i.e. one quarter of the circumference of the sprocket wheel. The quadrant may be an upper quarter of the circumference of the sprocket wheel.

A tensioning device may be included on the linear device for tensioning the linear device so as to hold it in sufficient co-operation with the respective driven wheel for driving the wheel. This greatly assists in the smooth lever drive action.

A tensioning device may be provided at both ends of the linear meshing device to hold it in sufficient co-operation with the gearwheel for driving the gearwheel.

The tensioning device may comprise a screw at either or both ends of the linear meshing device for tightening the chain, whereby the length of the chain is adjustable. A tension spring may be added at one end of the engaging device.

Further features which may be included are as follows:

The at least one drive lever may comprise one or more rigid portions joined together. The at least one drive lever may be made from suitable lightweight, strong, rigid material, such as aluminium alloy, titanium or carbon fibre.

It should be noted that throughout the term “transverse” means extending across the personal exercise machine and “transverse” should be taken to include perpendicular to a longitudinal centre line through the front and rear ends of the machine, but may also include variation from the perpendicular. Also, the term “stationary” should be taken to mean that the machine itself does not move from its location but includes a device which is movable by the person while exercising.

A stationary personal exercise machine according to the invention with a pair of levers, one on each side of a user support, may be propelled in a “Nordic Skiing” type of arm action, by alternately moving the lever arms repeatedly. This allows highly effective propulsion of the endless path device and also assists with stability.

### BRIEF DESCRIPTION OF THE DRAWINGS

Embodiments of the six aspects of the invention are now described, by way of example, with reference to the drawings (not to scale), in which:

FIG. 1 is a schematic perspective view of a first embodiment of a user-propelled wheeled vehicle according to the invention, which is in the form of a wheelchair;

FIG. 2 is a schematic perspective view of the wheelchair of FIG. 1, with the rear wheel spokes on the right hand side (as viewed looking forwards from the wheelchair) removed for clarity;

FIG. 3 is a schematic side view from the right (other side corresponds) of the wheelchair of FIG. 1, again with the wheel spokes removed for clarity;

FIG. 4 is a detailed schematic view from the rear end of a drive lever assembly according to the invention, employed on the rear right wheel of the wheelchair of FIG. 1;

FIG. 5 is a partially-exploded schematic perspective view of the wheelchair of FIG. 1, showing the lever assembly of FIG. 4, with wheel spokes again omitted for clarity;

FIG. 6 is another partially-exploded schematic perspective view of the wheelchair of the first embodiment, showing a mounting device employed in the lever assembly shown in FIGS. 4 and 5, (with wheel spokes again omitted for clarity);

FIGS. 7 to 12 is a series of schematic side views showing how the lever may be turned anti-clockwise from a forward position to a rearward position and in particular

FIG. 7 shows an extreme forward position of the lever, in which the lever does not engage the rear wheel;

FIG. 8 shows the lever having been turned a little anti-clockwise, as indicated by the arrow A, into engagement with the sprocket on the wheel hub at approximately the start of the forward stroke of the wheel;

FIG. 9 shows the lever having been turned a little further anti-clockwise, which moves the sprocket further forwards;

FIG. 10 shows the lever almost at the end of its anti-clockwise movement, having moved through an upright position and having moved the sprocket further forwards;

FIG. 11 shows the lever at the end of the forward stroke of the wheel; and

FIG. 12 shows the lever at its extreme rearward position in which it is detached from the wheel;

FIG. 13 is a detailed schematic view of the drive end of the drive lever employed in the embodiment illustrated in the earlier Figures;

FIG. 14 is a schematic perspective view of a second embodiment according to the invention, which will be referred to herein as a velocipede;

FIG. 15 is a partially-exploded schematic perspective view of the velocipede shown in FIG. 14, with the drive lever apparatus exposed for clarity on the right hand side rear wheel (as viewed looking forwards from the wheelchair);

FIG. 16 is an exploded schematic perspective view of a lever assembly according to the invention and associated lever mounting apparatus, employed in the second embodiment;

FIG. 16a is a close-up schematic view of part of FIG. 16;

FIG. 16b is a close-up end-on schematic view of the apparatus of FIG. 16a;

FIG. 17 is a schematic side view of the second embodiment (other side corresponds), without rear side wheels and without lever assemblies, to show the framework of the velocipede and its front wheel mounted on an extendable arm,

FIG. 18 is a partially-exploded schematic side view of the underlying chassis framework of the second embodiment, showing an extendable arm;

FIG. 19 is a schematic exploded view of an exploded diagrammatic view of the outer end of the extendable arm of the second embodiment together with a device for mounting the front wheel on the vehicle;

FIG. 19a is a schematic side view of the outer end of the extendable arm;

FIG. 20 is a close-up schematic side view showing the drive end of the lever assembly of the second embodiment

FIGS. 21 and 22 are schematic side views of the velocipede of the second embodiment showing how the lever may be turned from a forward position to a rearward position;

FIG. 23 is a schematic side view of the velocipede showing how the lever may be turned from a forward position and steered to the left;

FIG. 24 is a schematic side view of the second embodiment showing how the lever may be turned from a forward position and steered to the right;

FIG. 25 is a schematic view from the front end of the second embodiment of FIG. 14;

FIG. 26 is a schematic view from the rear end of the second embodiment;

FIG. 27 is a schematic perspective view of the velocipede in a fully folded mode;

FIG. 28 is a flow chart showing the steps of operating the at least one lever for propelling the vehicle according to the invention;

FIG. 29 is a composite view the relative positions of the or each lever with respect to the sprocket wheel on the driven wheel during STEP 1 of FIG. 28;

FIGS. 30a to 30h show in sequence individual stages of movement of the at least one lever employed in both the first and second embodiments according to the invention, from the beginning to the end of the drive stroke.

FIG. 31 is a diagrammatic side view of a further embodiment of the invention, with an arm lever in its position at the start of a forward stroke;

FIG. 32 is a rear view of the wheelchair of FIG. 31;

FIG. 33 is a diagrammatic side view of the wheelchair shown in FIGS. 31 and 32, with the arm lever in its position at the end of a forward stroke;

FIG. 34 is a schematic perspective view of a first embodiment of a generator having a drive lever according to a fourth aspect of the invention;

FIG. 35 is a schematic perspective view of the generator of FIG. 34, with the drive lever in an alternative position;

FIG. 36 is a schematic perspective view of the drive lever assembly employed in the generator of FIGS. 34 and 35;

FIG. 37 is a schematic perspective view of a first embodiment of a generator having a user support mounted between a pair of drive levers according to the fourth aspect of the invention;

FIG. 38 is a side view of a transmission device and alternator employed in the generator of FIG. 37;

FIG. 39 is a view from above showing the transmission device and alternator mounted on a shaft driven by the drive levers of the generator of FIG. 37;

FIG. 40 is a view of the drive end of a drive lever for use in generators according to the fourth aspect of the invention; and

FIG. 41 is a flow chart of the principal steps of operating the at least one lever, as described for the embodiments, for generating energy according to the fourth aspect of the invention;

FIG. 42 is a schematic perspective view of a first embodiment of a watercraft according to the invention;

FIG. 43 is a schematic side view of the watercraft of FIG. 42;

FIG. 44 is a schematic plan view of the watercraft of FIG. 42;

FIGS. 45a and 45b show in more detail right-hand and left-hand propulsion devices employed in the watercraft of FIGS. 1 to 3;

FIG. 46 is a schematic, partial view from underneath of a second embodiment of a watercraft according to the invention;

FIG. 47 is a view of the drive end of a drive lever for use in watercraft according to the invention; and

FIG. 48 is a flow chart of the principal steps of operating the at least one lever, as described for the embodiments of watercraft according to the invention;

FIG. 49 is a schematic view from the front and one side of a stationary personal exercise machine according to the invention;

FIG. 50 is a schematic side view of another embodiment of the personal exercise machine of FIG. 49;

FIG. 51 is a schematic exposed close-up view of the drive lever apparatus employed according to this aspect of the invention;

FIG. 52 is a partial close-up side view of the personal exercise machine of FIG. 50;

FIG. 53 is a schematic view of an endless path device employed in the personal exercise machines of FIGS. 49 and 50;

FIG. 54 is a view of the drive end of a drive lever for use in personal exercise machines according to this aspect of the invention; and

FIG. 55 is a flow chart of the principal steps of operating the at least one lever, as described for the embodiments of this aspect of the invention.

### BEST MODES OF CARRYING OUT THE INVENTION

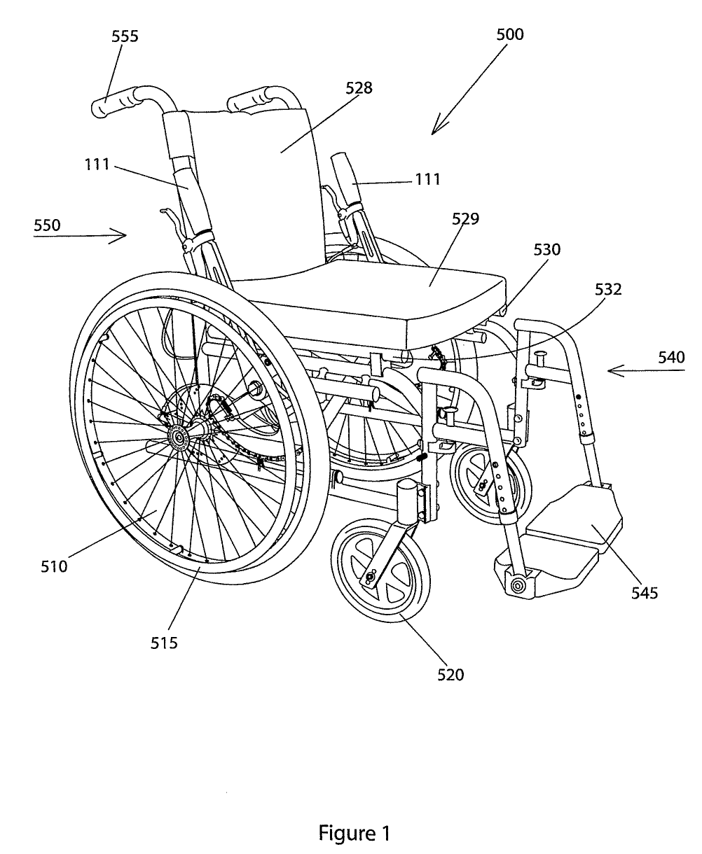

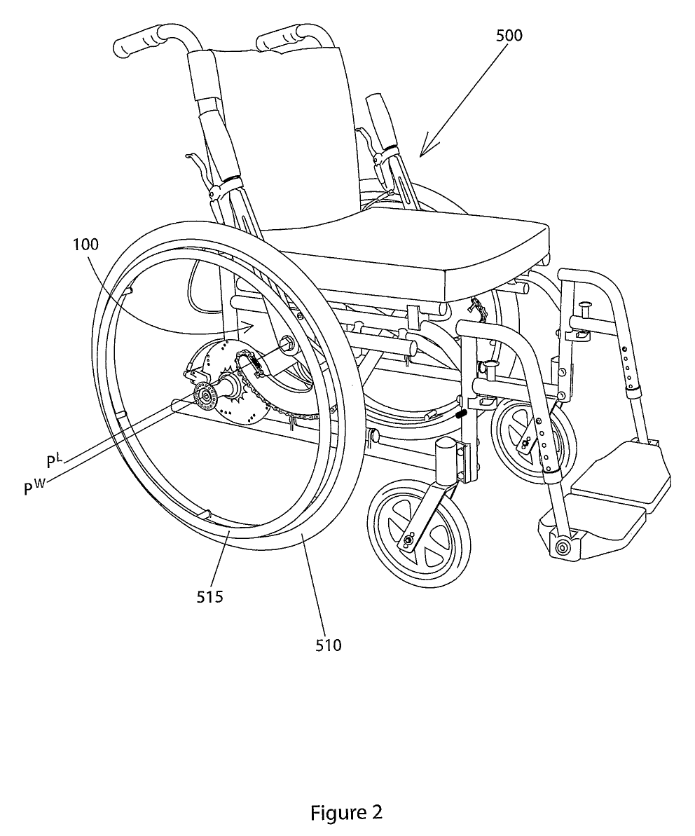

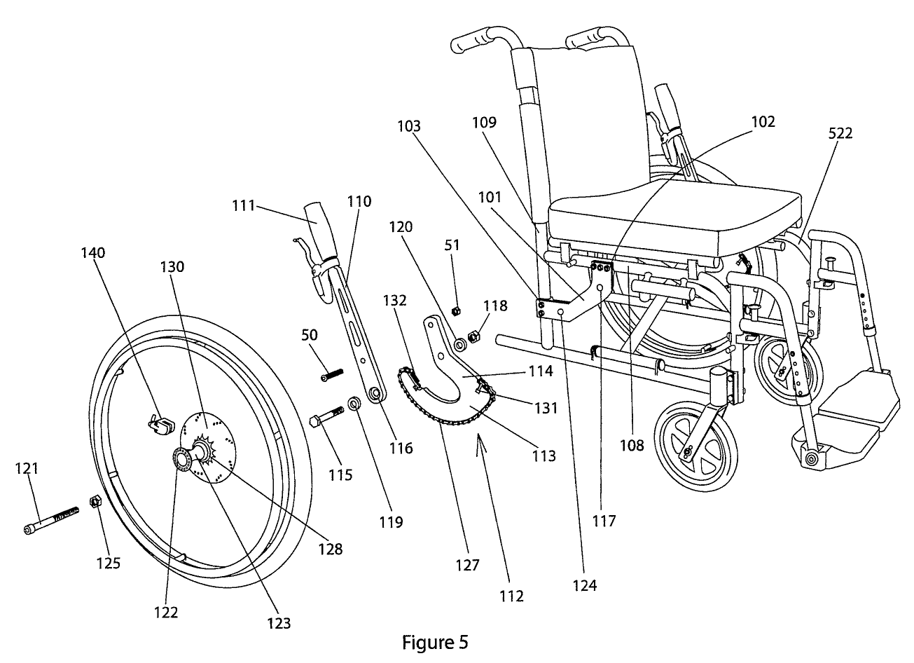

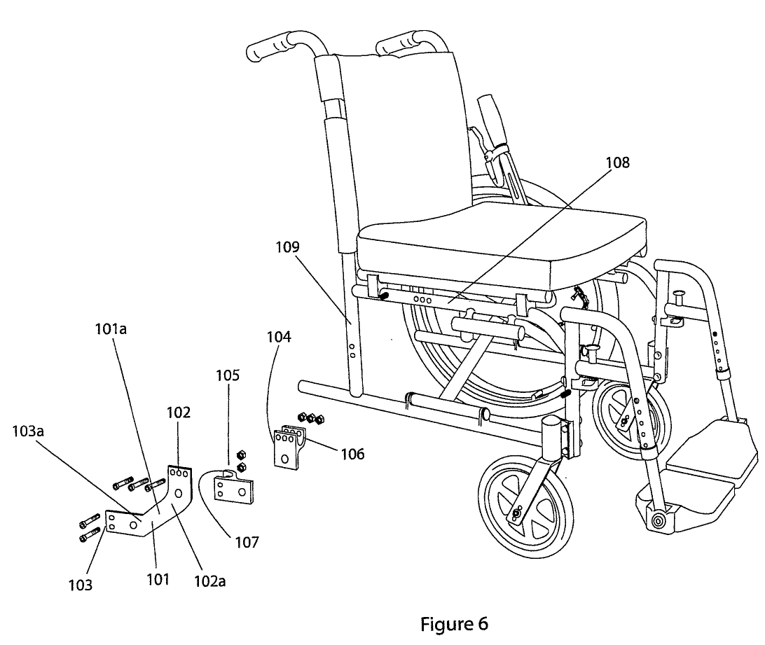

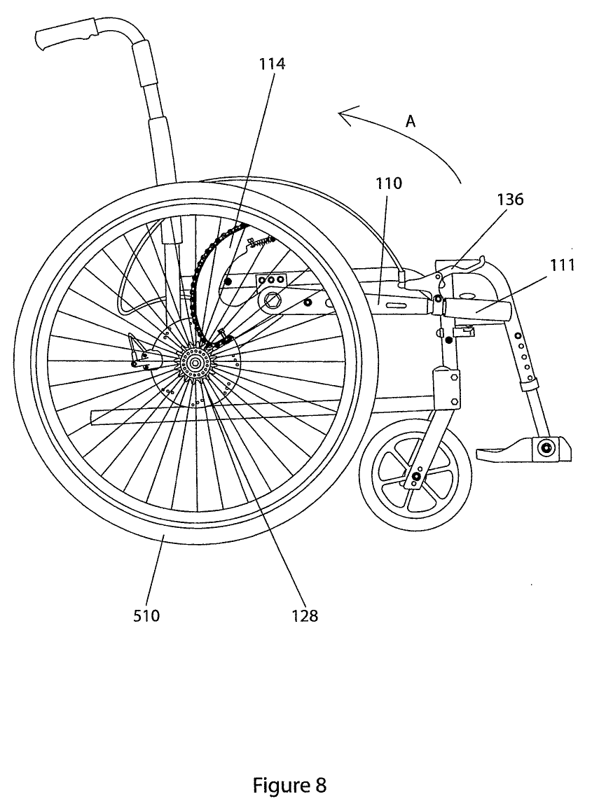

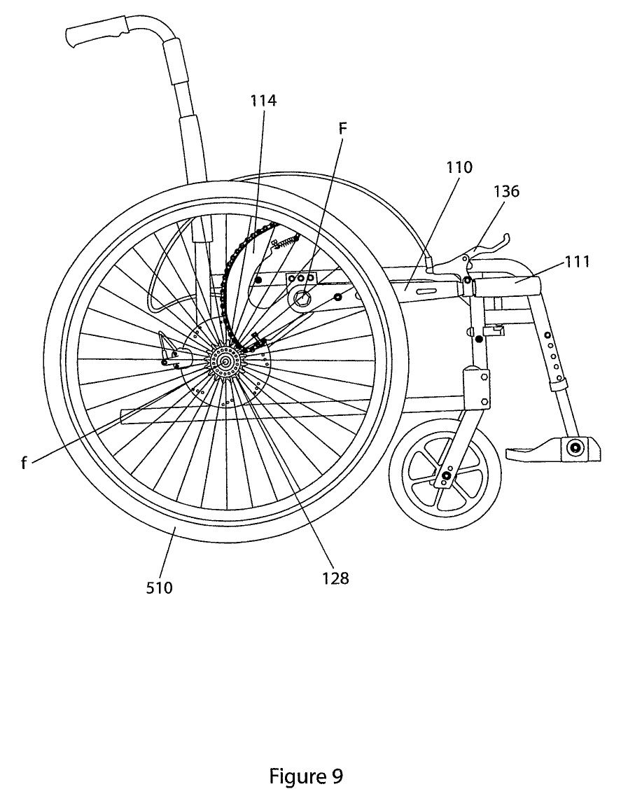

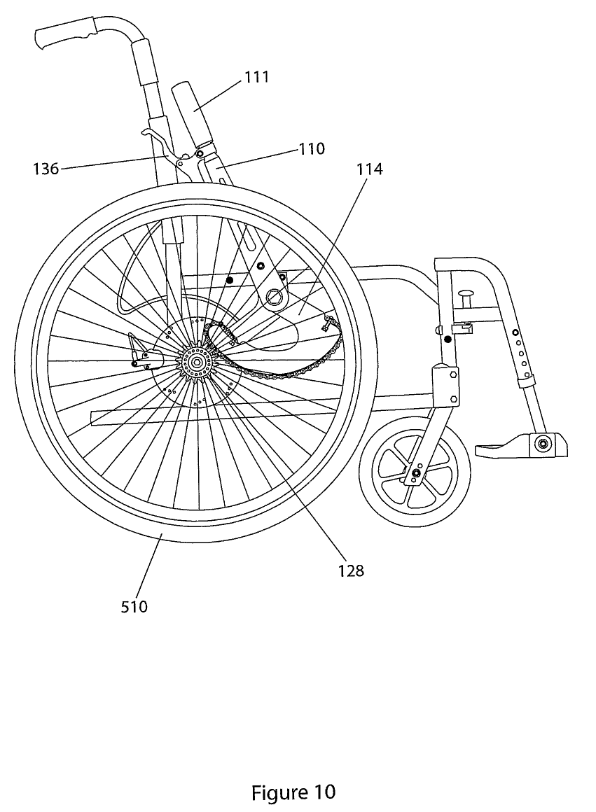

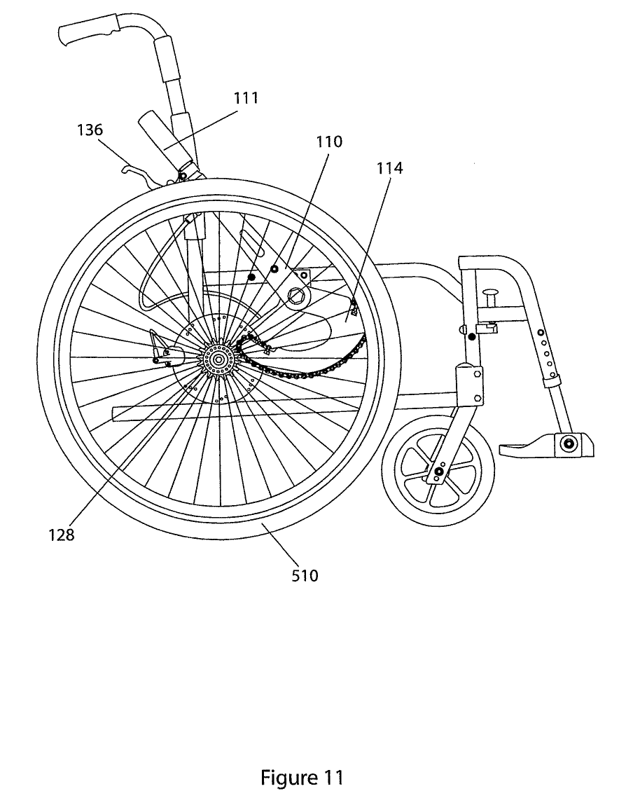

Referring to FIGS. 1 to 13 and 29 to 31 of the drawings, a human-powered wheelchair (500) has a pair of relatively large, driven rear left and right side wheels (510, 511), with external self-propel rims (515) (optional) and a pair of relatively small, front, non-driven wheels (520) for balancing the vehicle. The wheelchair has a tubular aluminium framework (522) (best shown in FIG. 5) providing a chassis. The chassis includes an approximately upright back (528) and an approximately horizontal seat (529), with padding, for supporting a user (not shown) and left and right sides (530, 532). The wheelchair is symmetrical about a longitudinal centre plane. Thus there is a rear side wheel in correspondingly the same position on each side of the seat. All views are assumed to be with respect to a person sitting on the seat, looking forwards in the direction of travel. The wheelchair has a forward end (540), with a foot rest (545), and a rearward end (550). The wheelchair also has an optional handle (555) for an attendant to push the chair.

This wheelchair has the following dimensions:

Length=36″

Height=36″

Width=18″

Seat height=22″

Wheelbase=26″

Weight of vehicle=approximately 10 kg

The basic wheelchair is of the type supplied by Medicare Technology under the Enigma Standard Aluminium range, which has 24″ self-propel, pneumatic rubber rear wheels and is designed for a single occupant weighing up to 115 kg. Large wheels of around this size allow a greater distance of travel per forward stroke of the lever. The wheelchair can be moved forward and backwards manually by propelling the external rear wheel rims (515). The front wheels are 8″ solid, rubber wheels and could be replaced by a longitudinal roller.

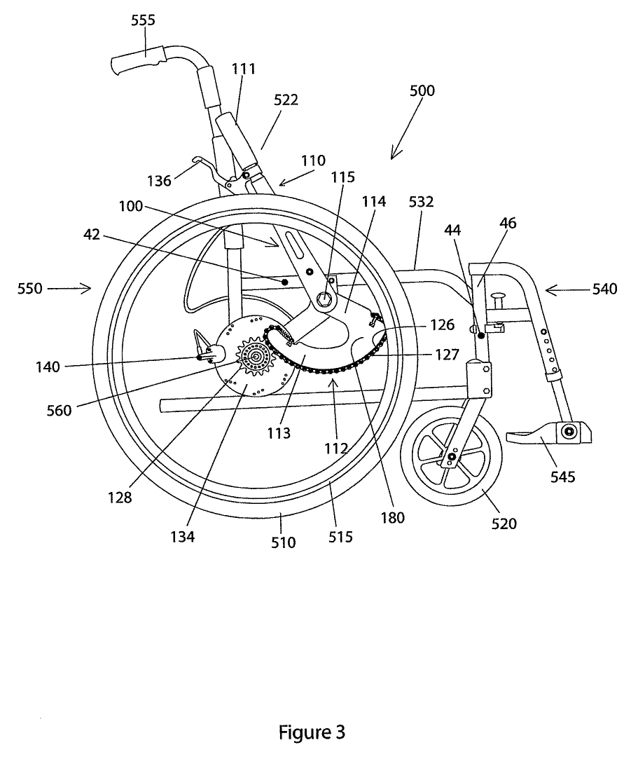

With reference in particular to FIGS. 3 and 5, the wheelchair further includes one drive lever assembly for each side for driving the rear side wheels. The drive lever assembly and the wheel arrangement are the same, and in correspondingly the same position, for both sides of the vehicle. The embodiment is manufactured originally with the drive lever assembly. Alternatively, the drive lever assembly may be supplied as a conversion kit for a conventional wheelchair.

Each lever assembly has:

a rigid lever (100)

a C-shaped brace plate (101)

fore and aft frame mounts (104, 105) and five pairs of nuts and bolts for attachment to the wheelchair

first fastening arrangement for fastening the lever to the brace

second fastening arrangement for fastening the wheel to the brace

a freewheel sprocket (128) which is to be mounted on the wheel and which is driven by the lever

a hydraulic disc brake (130) and a disc brake lever (136)

and associated nuts and bolts for fastening the assembly together and onto the wheelchair.

This drive lever assembly allows the wheelchair to be levered forwards and provides a highly effective means of transport. The wheelchair is particularly suitable as a mobility vehicle.

Each drive lever assembly is mounted on the wheelchair as follows:

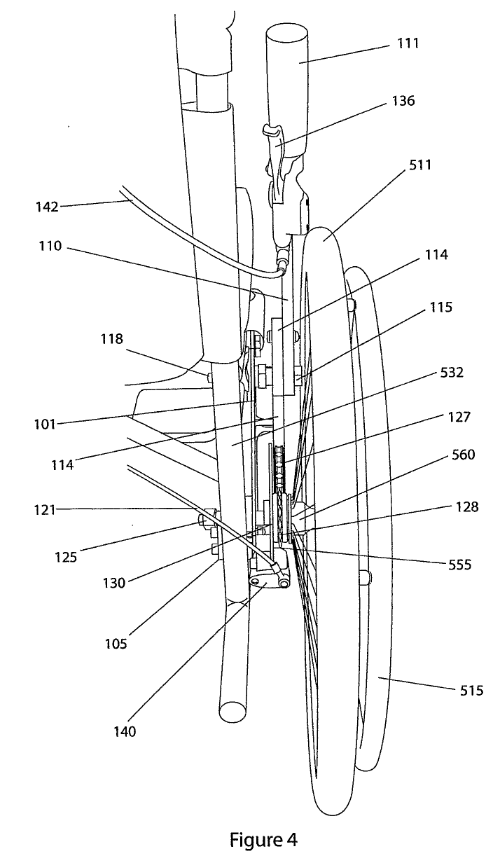

Referring to FIGS. 4, 5 and 6, the rigid lever (100) is mounted for free angular movement on a C-shaped brace plate (101), which is fastened to the seat at each of its ends (102, 103). Each drive end meshes with a respective 7 cm diameter sprocket wheel (555) co-axially mounted, inside the adjacent respective rear wheel (510, 511), on the hub of the respective wheel axle (560). Not only is this aesthetically beneficial but it also has unexpectedly been found to result in efficient leverage and effective driving.

The fore and aft ends (102, 103) of the brace plate are bolted to a respective one of fore and aft frame mounts (104, 105), each having a receiving portion (106, 107) which is complementarily-shaped to the adjacent strut on the chair framework. The fore end of the brace is fastened to a straight and a generally horizontal strut (108) of the chair framework via a straight and horizontal strut receiving portion (106), with three pairs of nuts and bolts, and the rear end (103) of the brace is fastened via a straight and vertical strut receiving portion (107) with a generally vertical strut (109), with two pairs of nuts and bolts. In the standard Enigma wheelchair the rear wheels are mounted directly on the upright strut (109) at the rear of the wheelchair via a similar bracket.

The fore end of the brace turns downwardly and to the rear in a fore first turn (102a) and then turns again towards the rear of the chair in an aft second turn (103a), providing a diagonal portion (101a) for strengthening at the rear of the sides of the chair.

Each lever has a straight, elongate, upper user-operable elongate upper portion (110) with a handle (111) conveniently at its upper end, and a remote, lower drive end portion (112), also referred to herein as a crank, which is rigidly connected with the user-operable elongate upper portion (110). The elongate upper portion (110) and drive member (112) are rigidly connected by a bolt (150) and nut (111) fixing, for movement one with the other; alternatively they may be integral.

The lower portions of the upper user-operable portions of the drive levers and the drive ends of the cranks of each lever arm are disposed in the space between the respective wheel and the adjacent side (530, 532) of the vehicle.

The lower drive end (112) has an arcuate drive portion (113), which is attached to with the user-operable upper portion (110) via an integral radial connecting member (114) (inclined outwardly away from the upper portion). The arcuate drive portion (113) and the radial connecting portion (114) are joined via an enlarged strengthening region (180).

The lower portions of the upper user-operable portions (110) of the drive levers and the drive ends of the cranks of each lever arm are disposed between the respective wheel and the adjacent side (530′, 532′) of the vehicle. Each drive end meshes with a respective 7 cm diameter sprocket wheel (555′) co-axially mounted at each side of the front wheel (101′) on the hub of the respective wheel axle (560′).

In this embodiment the user-operable elongate upper portion is approximately 40 cm long (from the pivot) and the radial member of the crank end is approximately 13 cm long; hence the ratio of the two is approximately 3:1. This ratio gives good leverage. These dimensions are generally suitable for 95% of people but the size of the lever can be varied for different people if they are having a wheelchair made to fit their personal requirements. Similarly the lever pivot may be made to suit personal requirements or determined for mass production by the ordinary person skilled in the art.

The lever (100) itself is pivotally mounted on the support brace (101) via a transverse pivot P^{L} or fulcrum (F) provided by a first fastening arrangement allowing a smooth pivotal action. This arrangement consists firstly of a lever bolt (115) located through a hole (116) in the lever, a confronting hole (117) in the C-brace, just below the fixing of the fore mount (104) to the framework and in the fore turn (102a) of the brace, and through the fore mount, and secondly a nut (118) fixed at the free remote end of the lever bolt.

Each rear side wheel is fixed to the side of the wheelchair for pivotal movement on a fulcrum (f) having a transverse pivot P^{W} axis, which is parallel to a transverse axis P^{L} through the fulcrum (F) of the drive lever, the driven wheel fulcrum (f) being located rearwards and downwards of the lever fulcrum (F). Thus, the lever pivot axis is spaced forwardly from a vertical line through the wheel pivot axis.

In this embodiment the distance between the two pivots is approximately 17 cm. At each side of the chair the rear side wheel is mounted (rearwardly of the lever pivot P^{L}) for pivotal movement on the C-brace provided by a second fastening arrangement again allowing a smooth pivotal action. This arrangement consists of firstly a wheel bolt (121) located through a central hole (122) through the wheel hub (123), through a confronting hole (124) in the C-brace, just in front of the fixing of the aft mount (105) to the framework and in the aft turn (103a) of the brace and through the aft mount, and secondly a nut (125) fixed at the free remote end of the wheel bolt (121).

The first and second fastening arrangements are stable and secure and so assist in providing smooth and effective rotation of the rear wheels, thereby resulting in smooth and effective travel of the wheelchair. The lever action is strong and reliable and also additionally assists in producing smooth and effective rotation of the rear wheels as will now be described.

The arcuate drive portion (112) has along its underside face (126) a length of bicycle-type roller chain (127) under tension, which consists of a series of regularly-spaced identical links and which is screw-fastened at each end under tension (discussed further below). The chain is 38 cm long and has 30 links of ½″ pitch (width) roller chain, as supplied by Air Bearings Ltd. The chain passes around forward and rearward and second curved ends (191, 192) of the crank underside face. The curved working part of the chain under the crank is approximately 32 cm long.

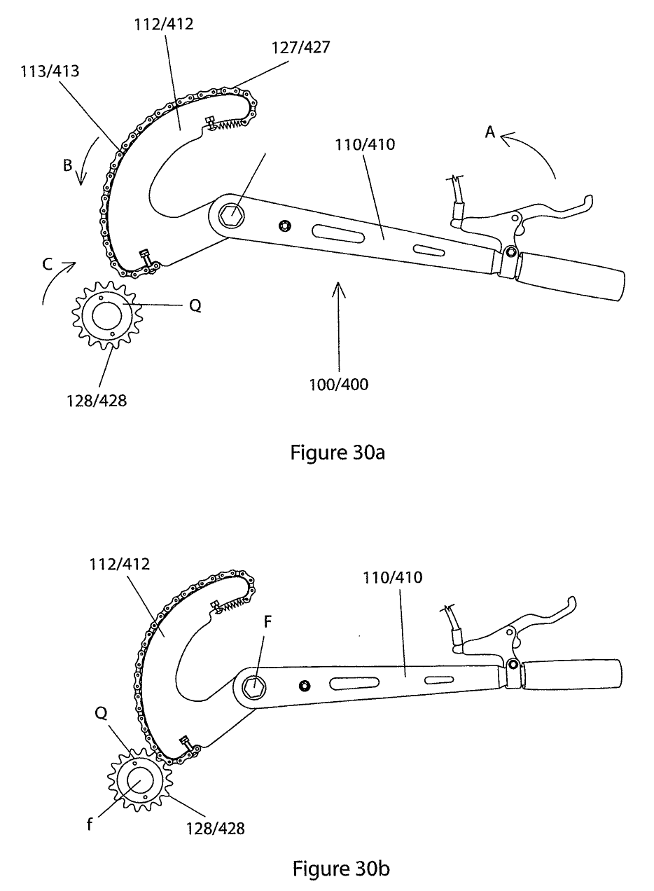

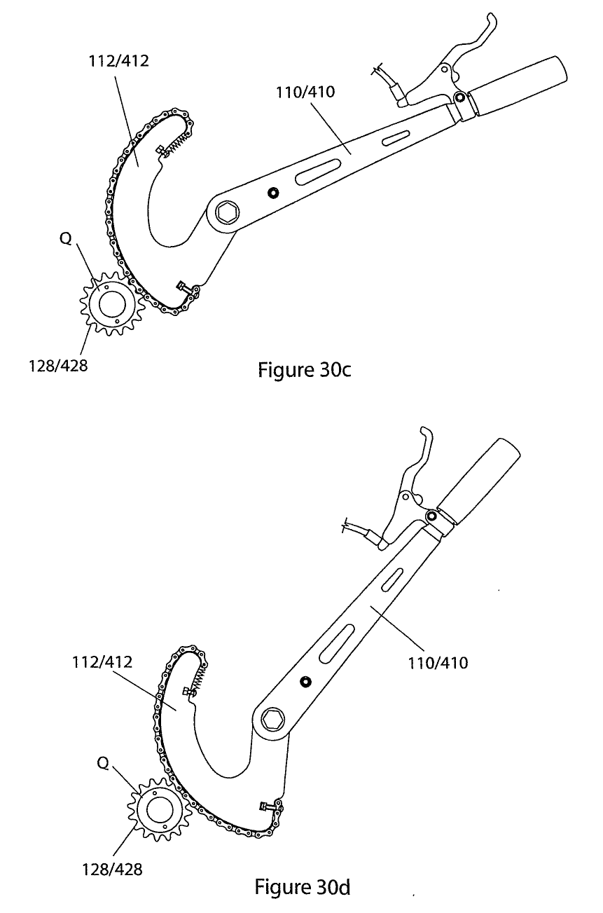

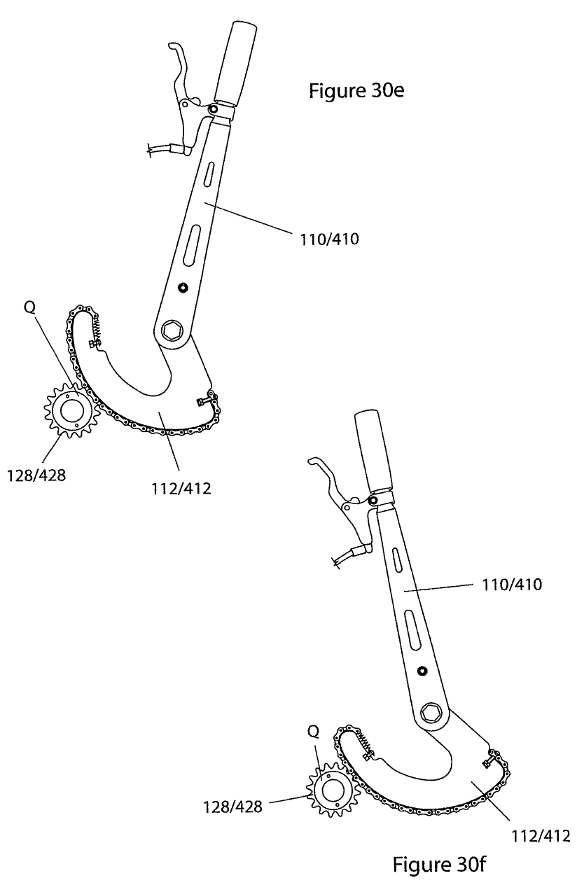

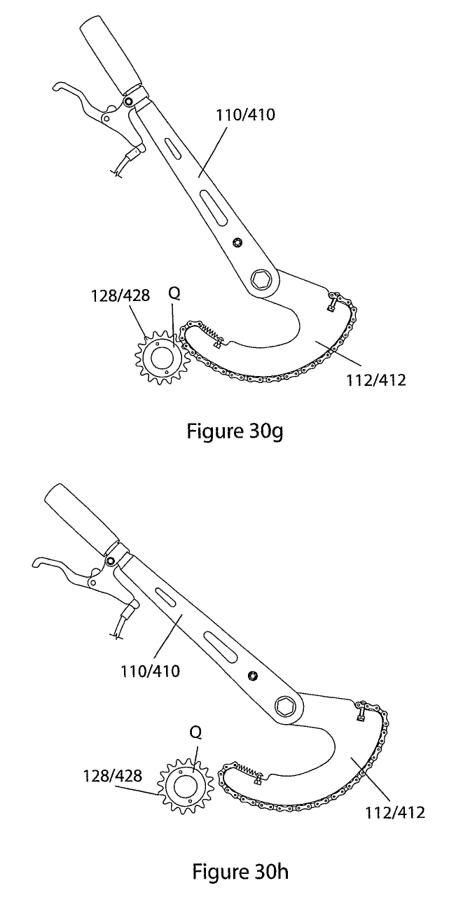

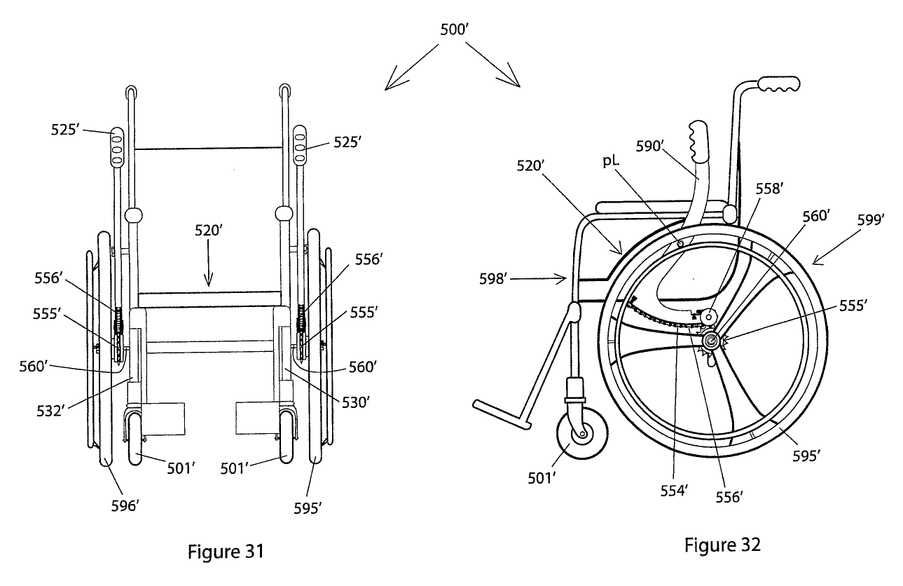

As shown in FIGS. 3 and 4, the chain (127) on each drive portion of each lever meshes with a respective 7 cm diameter sprocket wheel (128) mounted firstly co-axially on the wheel hub (560) of the rear wheel and secondly inwardly the rear wheel. In use the sprocket is driven by the chain (127) on the drive end of the lever. When the upper portion of the lever (110) is raised by a person sitting in the wheelchair using their hands or arms (in the direction shown by arrow A in FIG. 30a), the chain (127) will engage with the sprocket wheel (128) to move it forwards, thereby propelling the velocipede forwards. The lever movement is illustrated in FIGS. 30a to 30h and in FIG. 31, which will be discussed further below.

The sprocket wheel (128) has an outer annular sprocket wheel with identical, regularly spaced teeth (555) on a concentric inner annular wheel which houses an internal ratchet and pawl stop device to engage with the outer wheel. The stop device allows the outer wheel to only rotate in the forwards direction together with the inner wheel but the outer wheel may rotate rearwards without the inner wheel to allow the wheelchair to freewheel forwards. In addition the wheelchair may be used conventionally, so as to be moveable rearwards and to adjust the orientation of the chair, for example while in a particular location.

In this embodiment the sprocket wheel (128) is a brass single speed, freewheel gear of the type supplied by Lovson Exports Ltd under model no. LCS-110, having 16 teeth and these teeth mesh with a ½″ pitch roller chain. A single roller fits snugly between a pair of adjacent teeth. The sprocket on the right of the wheelchair (looking forwards) is a right hand drive sprocket and the sprocket on the other side is a left hand version of the same sprocket.

When the drive end of the lever is turned clockwise in the direction of arrow B in FIG. 30a as a result of turning the upper end of the lever anti-clockwise, direct drive on the rear side wheels is obtained, thereby turning the sprocket wheel and associated rear wheels forwards. Thus repeated lever action directly on the respective driven wheels propels the vehicle forwards and travel may be obtained. The levers may be used together or in turn in a “Nordic skiing” style, which results in highly effective travel. The wheelchair can be continuously propelled forwards over long distances as required. The wheelchair is highly maneuverable. The wheelchair is steered by using the brake on the other lever to that lever being used for driving at any particular time. They may each be used for steering at different times.

After reaching the end of the upward anti-clockwise stroke, each upper portion of the lever (100) is pushed forwards in a clockwise return stroke, with the chain of the drive portion of the lever rolling over the sprocket wheel; at the same time the respective driven wheel of the wheelchair is allowed to freewheel forwards, with there being no driving action. Consequently the wheelchair still travels forwards. The lever may be fully off the sprocket wheel during freewheeling but this is not necessary for the freewheeling to take place.

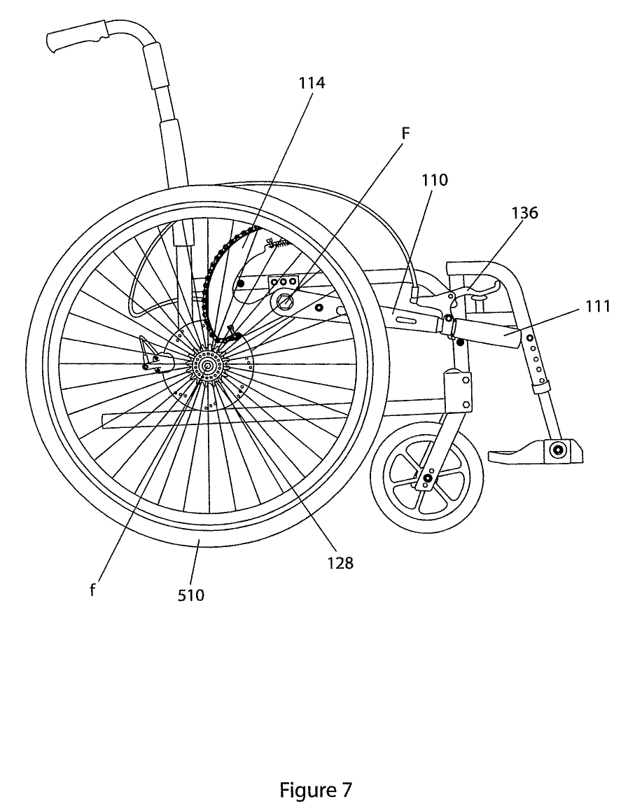

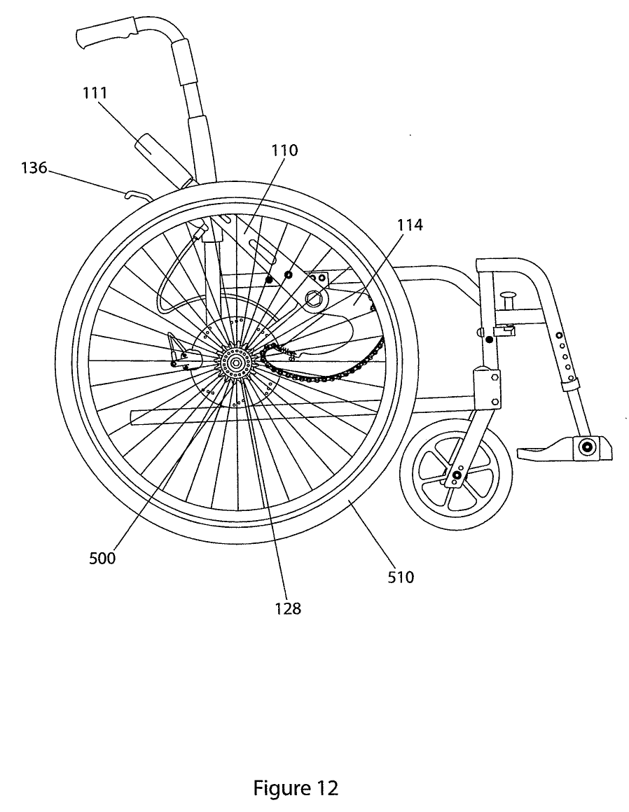

In the extreme forward and rearward positions shown in FIGS. 7 and 12, the lever becomes detached from the sprocket wheel (128) to allow the user to manually turn the external rim to rotate the wheel as desired.

A hydraulic disc brake (130) is provided for each lever arm: a disc brake (134) is mounted for braking action on the axle (560) of each large side wheel (510). The brake disc (434) is disposed between the rear wheel and the adjacent lever (400). Each disc brake is of conventional construction, with a double caliper (140) acting on the disc on each wheel. Each brake may be activated by a respective lever (136) on each vehicle lever, connected thereto by a cable (142) containing hydraulic fluid. This provides progressive braking action, which is gentle but also effective. The hydraulic disc brake is a conventional mountain bike hydraulic disc brake as sold under model number DEORE BR-M555 type by Shimano, which has an opposed piston design and strong stopping power and precision control. The brake lever is a Shimano BL-M556, compatible with the BL-M555 disc brake. The brake lever is disposed behind the lever slightly inwardly for ease of use as shown in FIG. 4.

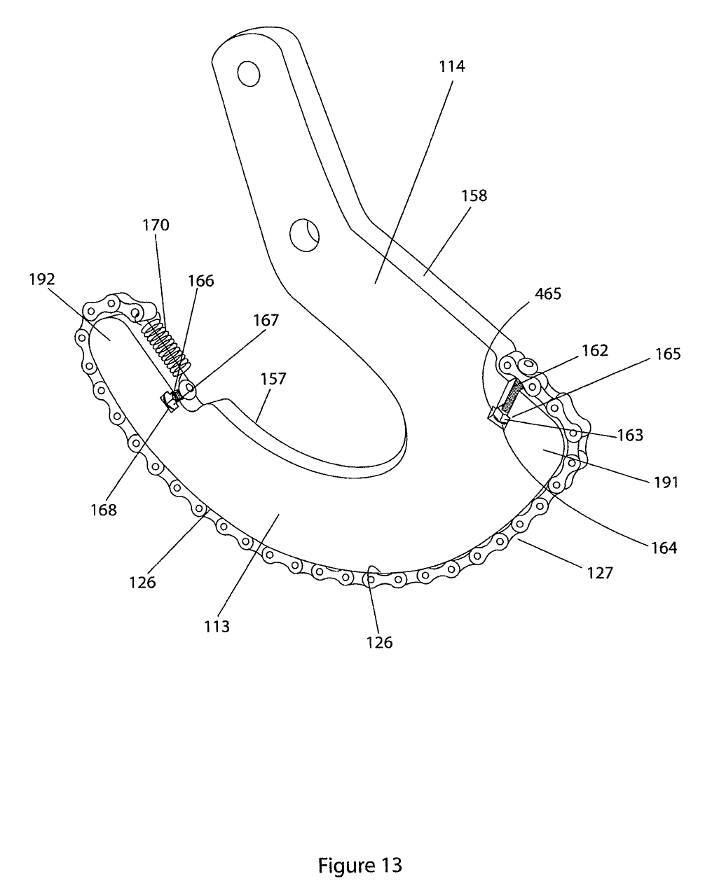

As shown in FIG. 13, the front end of the drive chain (127) is fastened, around the forward end of the drive member and up the front (158), by a screw (162) having a nut (163) at its non-head end. The nut is seated in an undercut recess (164) so that it acts against the upper face (165) of the recess, to allow adjustment of the screw to provide a desired fit of the chain against the drive portion. The chain is fastened, at its rear end, to the topside (157) of the arcuate drive portion by a smaller similar screw (166), nut (167) and undercut recess (168), with an upper face (169) against which the nut acts, but the end of the chain is connected to the screw via a sprung steel tension spring (170). The rear end may again be tightened (or slackened) to provide a desired fit of the chain against the drive portion.

It is possible that the chain may slacken in use over time and this arrangement allows it to be tightened to optimise the drive action of the wheelchair. It has been found that this tightening arrangement provides reliable engaging of the chain with the sprocket wheel. This tensioning also assists in providing a smooth lever drive action.

The wheelchair may be used for disabled people or as a mobility vehicle for the elderly or infirm. In another form, the levers may again be mounted at the sides of the vehicle in such a way that they can be pushed down to move the vehicle forwards; this might be suitable for disabled people without legs. In this case the lever pivot axis is arranged rearwards of a vertical line through the wheel pivot axis.

It should also be noted that the rear side wheels may be smaller than as shown and in such case, the lever will be proportionally longer.

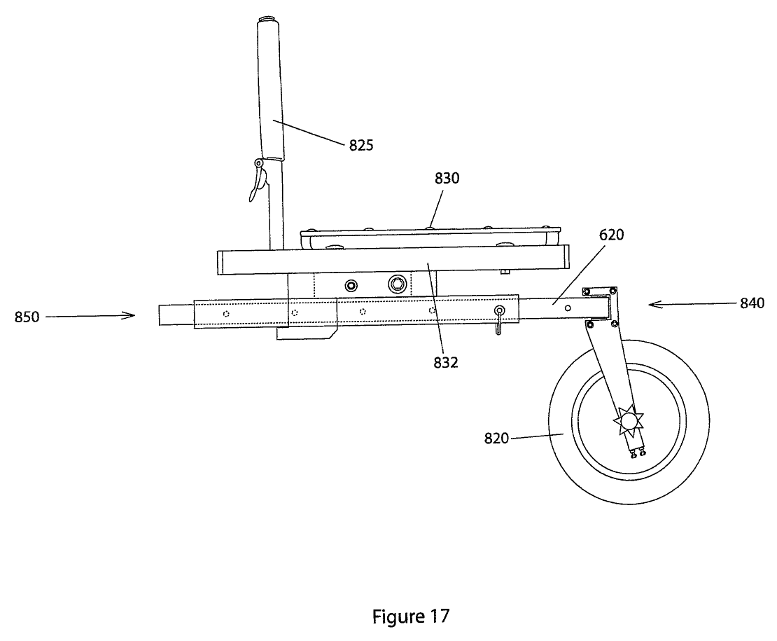

With reference to FIGS. 14 to 30 of the drawings, a second embodiment of a user-propelled wheeled vehicle according to this invention will now be described. In this embodiment the vehicle has the same lever driving arrangement on both its rear side wheels as the wheelchair just described. The vehicle will be referred to as a velocipede but it is especially suitable for use for sport and recreation and can also be called a human-powered go-kart. This vehicle has been unexpectedly found to be capable of highly effectively travelling over ground having variable gradient, especially sudden changes for example curbs.

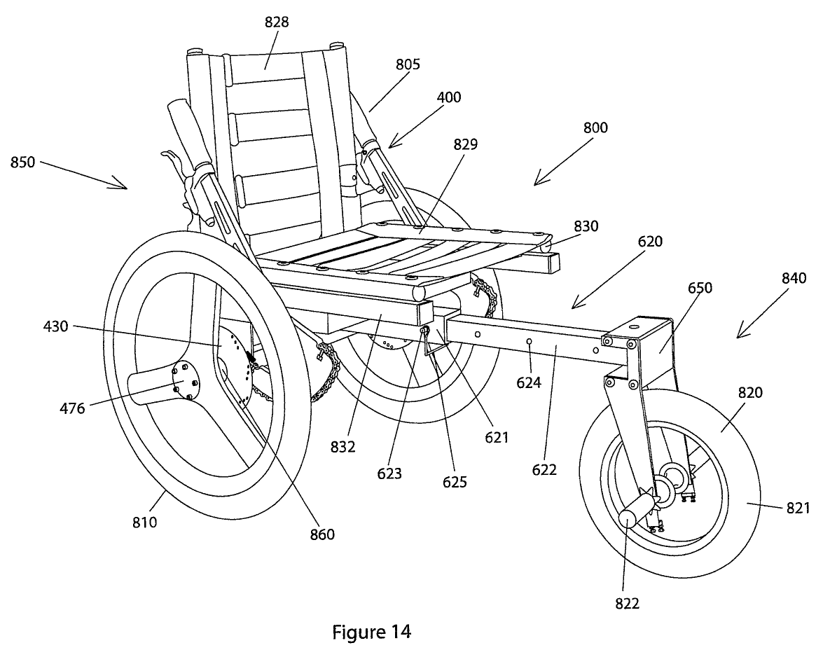

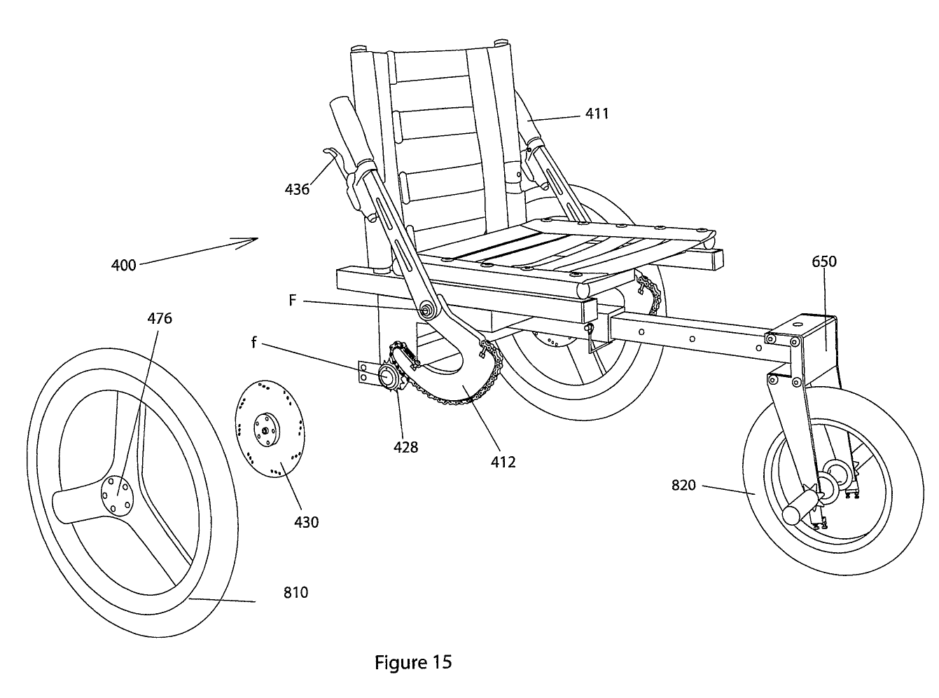

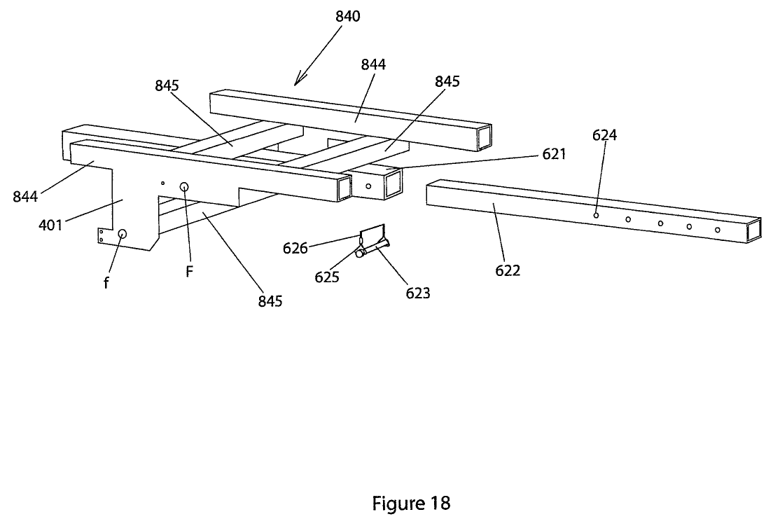

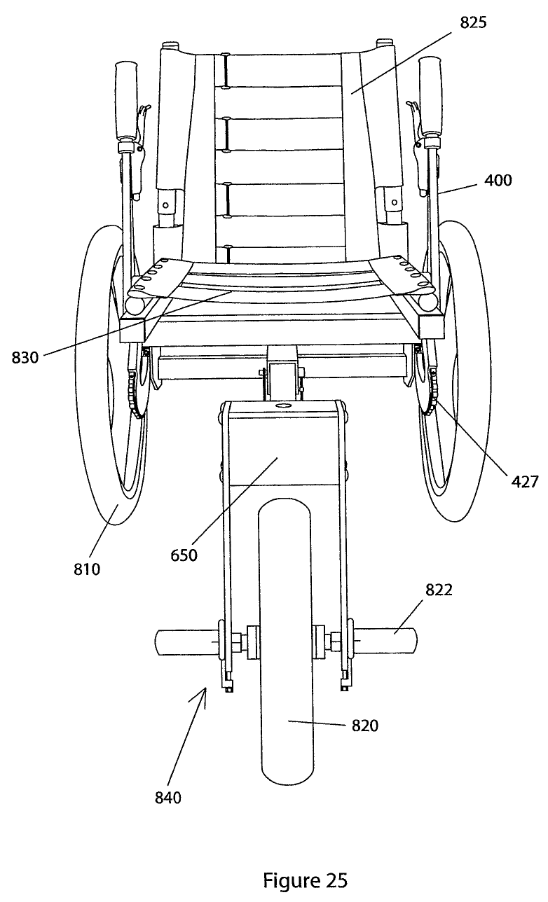

Referring to FIG. 14, the velocipede (800) has a pair of relatively large, driven rear side wheels (810) and a single relatively small, front, non-driven wheel (820) for balancing the vehicle. Referring to FIG. 18, the velocipede has a welded framework (840) made from a spaced pair of longitudinal aluminium box-shaped members (844) and upper and lower spaced transverse aluminium box-shaped members (845). As shown in FIGS. 14 and 15 in particular, this framework (840) provides a chassis for a seat including an approximately upright back rest (829) and an approximately horizontal seat (830), with strapping for supporting a user, and left and right sides (830, 832) (shown in FIGS. 14 and 15). The velocipede is symmetrical about a longitudinal centre plane, as shown in FIGS. 25 and 26.

The velocipede can be folded down for transport as shown in FIG. 27. Thus there is a rear side wheel (810) in correspondingly the same position on each side of the seat. All views are assumed to be with respect to a person sitting on the seat, looking forwards in the direction of travel. The velocipede has a forward end (840) and a rearward end (850).

The front wheel (820) is centrally disposed with respect to the longitudinal centre plane and it is mounted on the forward end of an extendable shaft (620) as will be described later. In this embodiment, suitable for a teenager, the velocipede has the following dimensions:

Length=40″

Height=30″

Width=16″

Seat height=18″

Wheelbase=24″

Weight of vehicle=approximately 8 kg

For different age groups, the dimensions may be different. The velocipede of the embodiment has 20″ rear wheels and a 12″ front wheel; the wheels are all rubber pneumatic but they may be solid. Larger wheels may be used for a faster vehicle. The velocipede can be moved forward and backwards manually by propelling the external rear wheels. The front wheel could be replaced by an alternative steerable balancing device such as a tiltable ball.

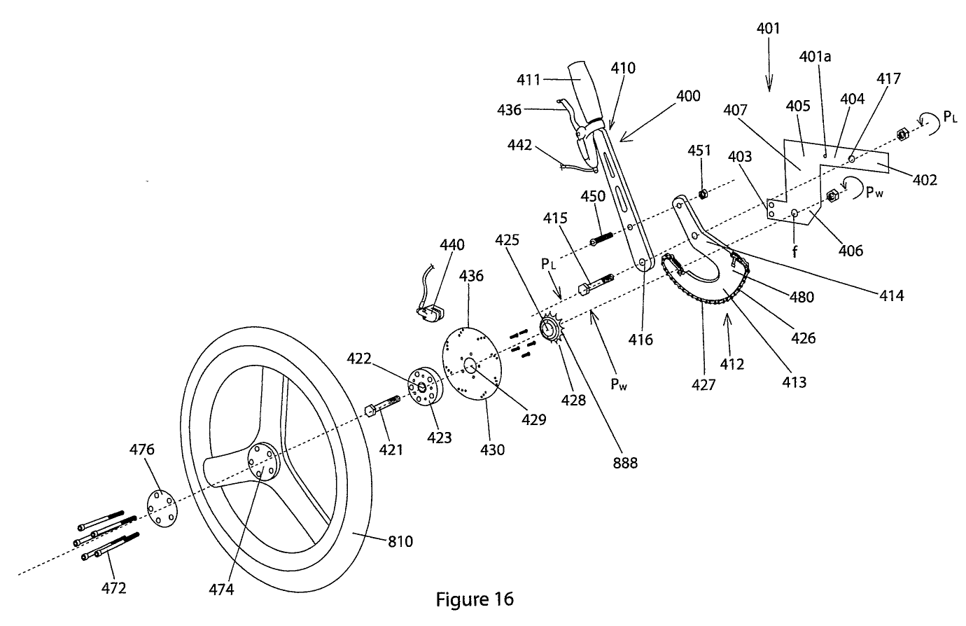

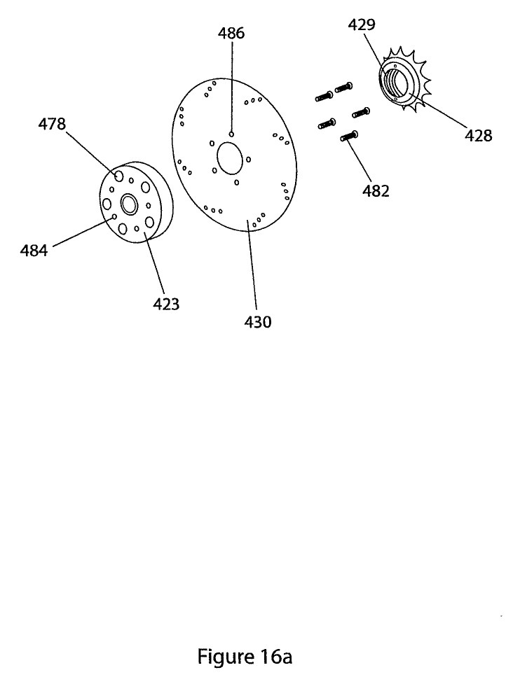

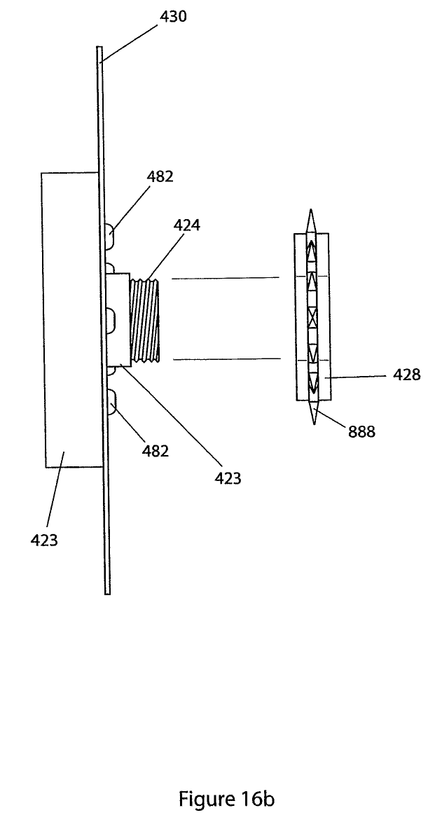

With reference in particular to FIGS. 15 and 16, the velocipede further includes one drive lever assembly for each side for driving the rear side wheels. The drive lever assembly and the wheel arrangement are the same, and in correspondingly the same position, for both sides of the vehicle. The velocipede is manufactured originally with the drive lever assembly. Alternatively, again the drive lever assembly may be supplied as a conversion kit for a conventional velocipede.

Each drive lever assembly has:

a rigid lever (400)

an angular S-shaped brace plate (401)

fore and aft pairs of nuts and bolts for attachment of the lever assembly to the velocipede

first fastening arrangement for fastening the lever to the brace

second fastening arrangement for fastening the wheel to the brace

a freewheel sprocket (428) which is to be mounted on the wheel and which is driven by the lever

a hydraulic disc brake (430) and a disc brake lever (436)

and associated nuts and bolts for fastening the assembly together and onto the velocipede.

This drive lever assembly allows the velocipede to be propelled forwards and provides a highly effective means of transport. The velocipede is particularly suitable as a human-powered sports or recreational go-kart.

Each drive lever assembly is mounted on the velocipede as follows:

Referring to FIGS. 16, 16a and 16b, the rigid lever (400) is mounted for free angular movement on the S-shaped brace plate (401), which is welded to and fastened to the seat at a location (401a) towards its front end (402) and at a location near its rear end (403). Each drive lever assembly is disposed between the wheel and the respective adjacent side (830, 832) of the velocipede. Not only is this aesthetically beneficial but it also has unexpectedly been found to result in efficient leverage and effective driving.

The portion (404) of the brace leading to the fore end (402) is straight and turns vertically downwardly in an upper first turn (405) and then turns again towards the rear of the chair in a lower second turn (406), providing a vertical portion (407) for strengthening at the rear of the sides of the velocipede.

Each lever has a straight, elongate, user-operable upper portion (410) with a handle (411) conveniently at its upper end, and a remote, lower drive end portion (412), also referred to herein as a crank, which is rigidly connected with the user-operable elongate upper portion (410). The elongate upper portion and the drive member are rigidly connected by a bolt (450) and nut (451) fixing, for movement one with the other; alternatively they may be integral.

The lower drive end (412) has an arcuate drive member portion (413), which is attached to the upper portion (410) via an integral radial connecting member (414) (inclined outwardly away from the upper portion). The arcuate drive member (413) and the radial connecting member (414) are joined via an enlarged strengthening region (480).

In this embodiment the user-operable elongate upper portion is approximately 40 cm long (from the pivot) and the radial member of the crank end is approximately 13 cm long; hence the ratio of the two approximately 3:1. This ratio gives good leverage. These dimensions are generally suitable for 95% of people but the size of the lever can be varied for different people if they are having a velocipede made to fit their personal requirements. Similarly the lever pivot may be made to suit personal requirements or determined for mass production by the ordinary person skilled in the art.

The lever (400) itself is pivotally mounted on the support brace (401) via a transverse fulcrum (F) provided by a first fastening arrangement allowing a smooth pivotal action. This arrangement consists firstly of a lever bolt (415) located through a hole (416) in the lever, a confronting hole (417) in the S-brace, just fore of the fixing (401a) to the framework and in the fore portion (404) of the brace, and secondly a nut (418) fixed at the free remote end of the lever bolt.

Each rear side wheel is fixed to the side of the velocipede for pivotal movement on a fulcrum (f) having a transverse pivot axis P_{W}, which is parallel to a transverse axis P_{L} through the fulcrum (F) of the drive lever, the driven wheel fulcrum (f) being located rearwards and downwards of the lever fulcrum (F). Thus, the lever pivot axis is spaced forwardly from a vertical line through the wheel pivot axis.

The distance between the two pivots is again approximately 17 cm. At each side of the chair the rear side wheel is mounted, rearwardly of the lever pivot P_{L}, for pivotal movement on the S-brace provided by a second fastening arrangement again allowing a smooth pivotal action. This arrangement consists firstly of a wheel bolt (421) located through a central hole (422) through the wheel hub (423), a confronting central hole (429) in a confronting brake disc (430) (described in more detail later), a confronting central hole (425) in a confronting sprocket (428) (described in more detail later), and a confronting hole (417) in the S-brace, just forwardly of the aft fixing to the framework and in the aft turn (406) of the brace, and secondly a nut (125) fixed at the free remote end of the wheel bolt.

The first and second fastening arrangements are stable and secure and so assist in providing smooth and effective rotation of the rear wheels, thereby resulting in smooth and effective travel of the velocipede. The lever action is strong and reliable and also additionally assists in producing smooth and effective rotation of the rear wheels as will now be described.

The arcuate drive portion (413) has along its underside face (426) a length of bicycle-type roller chain (427) under tension, consisting of a series of regularly-spaced identical links and which is screw-fastened at each end under tension (discussed further below). The chain is 38 cm long and has 30 links of ½″ pitch (width) roller chain, as supplied by Air Bearings Ltd. The chain passes around forward and rearward curved ends (491, 492) of the crank underside face. The curved working part of the chain under the crank is approximately 32 cm long.

The lower portions of the upper user-operable portions of the drive levers and the drive ends of the cranks of each lever arm are disposed between the respective wheel and the adjacent side (530′, 532′) of the vehicle. With reference to FIG. 15, the chain (427) on each drive portion meshes with a respective 7 cm diameter sprocket wheel (428) co-axially mounted on the wheel hub (860), which also acts as a spacer. In use the sprocket is driven by the chain (427) on the drive end of the lever. When the upper portion of the lever (410) is raised by a person sitting in the velocipede using their hands or arms (in the direction shown by arrow A in FIG. 30a), the chain (427) will engage with the sprocket wheel (428) to move it forwards, thereby propelling the velocipede forwards. The lever movement is again as illustrated in FIGS. 30a to 30h and in FIG. 31, which will be discussed further below.

The sprocket wheel (428) has an outer annular sprocket wheel with identical, regularly spaced teeth (888) on a concentric inner annular wheel which houses an internal ratchet and pawl stop device to engage with the outer wheel. The stop device allows the outer wheel to only rotate in the forwards direction together with the inner wheel but the outer wheel may rotate rearwards without the inner wheel to allow the velocipede to freewheel forwards. In addition the velocipede may be used conventionally, so as to be moveable rearwards and to adjust the orientation of the velocipede while in a particular location.

In this embodiment the sprocket wheel (128) is a brass single speed, freewheel gear of the type supplied by Lovson Exports Ltd under model no. LCS-110, having 16 teeth and these teeth mesh with a ½″ pitch roller chain. A single roller fits snugly between a pair of adjacent teeth. The sprocket on the right of the velocipede (looking forwards) is a right hand drive sprocket and the sprocket on the other side is a left hand version of the same sprocket.

When the drive end of the lever is turned clockwise in the direction of arrow B in FIG. 30a as a result of turning the upper end of the lever anti-clockwise, direct drive on the rear side wheels is obtained, thereby turning the sprocket wheel and associated rear wheels forwards. In summary, the cranks move together with the levers about the horizontal pivot axis P_{L} and the drive portion is movable by the lever simultaneously therewith. Hence repeated lever action directly on the respective driven wheels propels the vehicle forwards and travel may be obtained. The levers may be used together or in turn in a “Nordic skiing” style, which results in highly effective travel. The velocipede can be continuously propelled forwards over long distances as required. The velocipede is highly maneuverable and has a very smooth lever action.

After reaching the end of the upward anti-clockwise stroke, each upper portion of the lever (400) is pushed forwards in a clockwise return stroke, with the chain of the drive portion of the lever rolling over the sprocket wheel; at the same time the respective driven wheel of the wheelchair is allowed to freewheel forwards, with there being no driving action. Consequently the wheelchair still travels forwards. The lever may be fully off the sprocket wheel during freewheeling but this is not necessary for the freewheeling to take place.

In the extreme forward and rearward positions of the lever, the lever becomes detached from the sprocket wheel (428) to allow the user to manually turn the rear wheels.

A hydraulic disc brake (430) is provided for each lever arm: a disc brake (434) is mounted for braking action on the axle (860) of each rear wheel (810). The brake disc (434) is disposed between the rear wheel and the adjacent lever (400). Each disc brake is of conventional construction, with a double caliper (440) acting on the disc on each wheel. Each brake may be activated by a respective lever (436) on each vehicle lever, connected thereto by a cable (442) containing hydraulic fluid. This provides progressive braking action, which is gentle but also effective. The hydraulic disc brake is a conventional mountain bike hydraulic disc brake as sold under model number DEORE BR-M555 type by Shimano, which has an opposed piston design and strong stopping power and precision control. The brake lever is a Shimano BL-M556, compatible with the BL-M555 disc brake. The brake lever is disposed behind the lever slightly inwardly for ease of use as shown in FIG. 25.

Referring to FIG. 16, the rear wheels (810) of the velocipede are attached to the vehicle so that they may be quickly put on and taken off as desired, without disturbing the brake and lever arrangement. A set of five screws (472) passes through confronting holes in the wheel hub (474) via a cover plate (476) with matching confronting holes for the passage of the screws (472). The threaded ends of these screws screw into confronting threaded holes (478) in the wheel hub spacer disc (423). As shown in FIGS. 16a and 16b, the sprocket wheel (430) has an annular internally-threaded region, which is fastened onto an externally-threaded region (424) (extending inwardly of the vehicle and therefore not shown in other views) of the wheel hub spacer disc (423). The wheel hub spacer disc (423) is itself fastened to the brake disc (430) by means of a set of five smaller screws (482), which screw into threaded holes (484) in the wheel hub spacer disc (423) via matching confronting holes (486) in the brake disc (430). As a result a contiguous secure assembly is provided, which at the same time allows smooth rotational movement of the wheel.

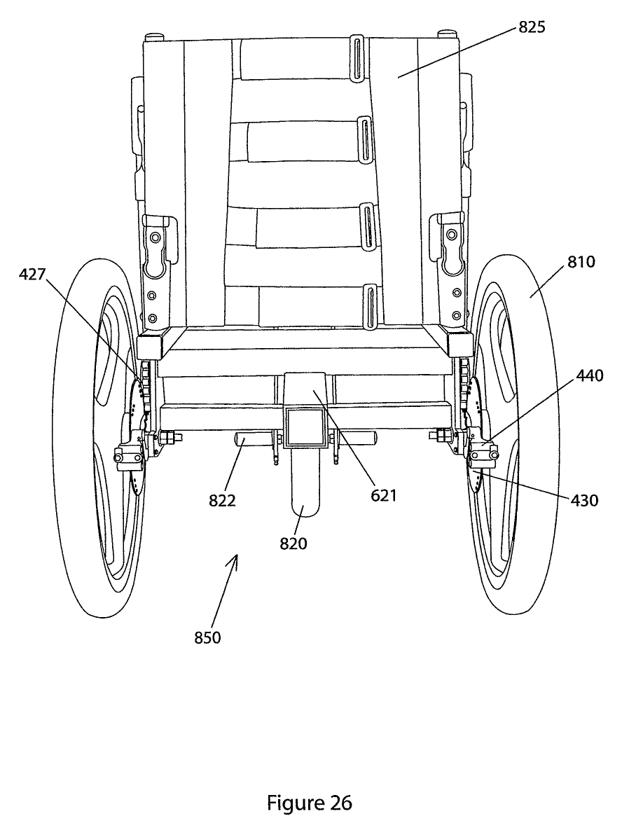

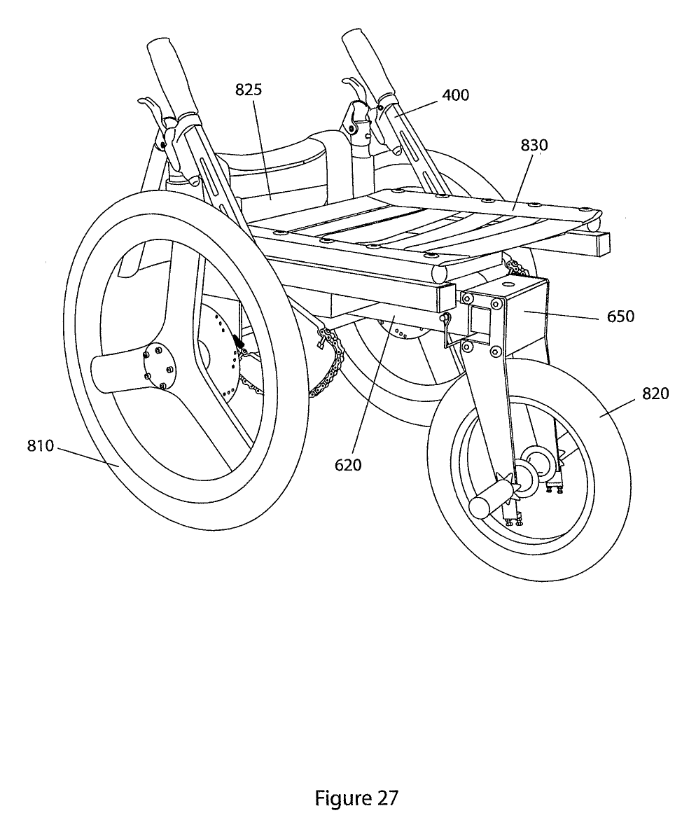

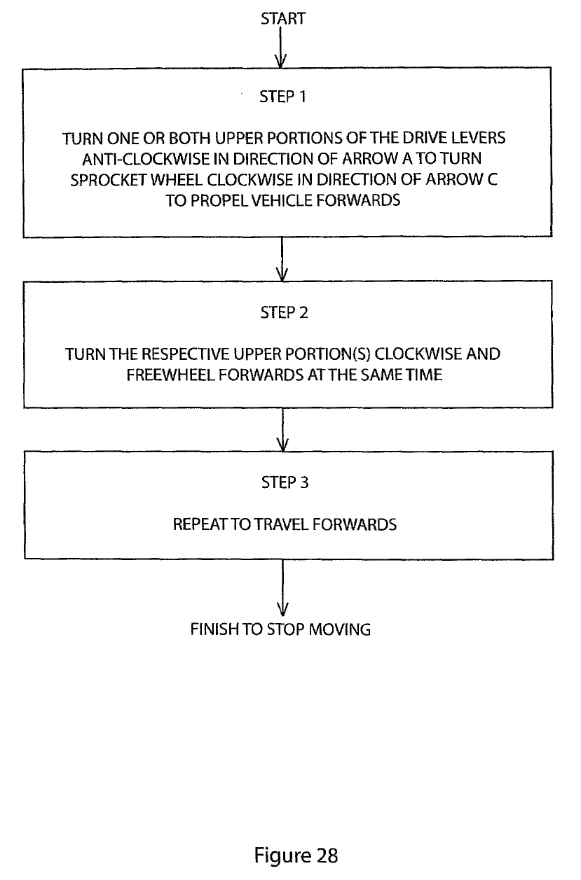

As shown in FIG. 28, the front end of the drive chain (427) is fastened around the forward end of the drive member and up the front (458), by a screw (462) having a nut (463) at its non-head end. The nut is seated in an undercut recess (464) so that it acts against the upper face (465) of the recess, to allow adjustment of the screw to provide a desired fit of the chain against the drive portion. The chain is fastened, at its rear end, to the topside (457) of the arcuate drive portion by a smaller similar screw (466), nut (467) and undercut recess (468), with an upper face (469) against which the nut acts, but the end of the chain is connected to the screw via a sprung steel tension spring (470). The rear end may again be tightened (or slackened) to provide a desired fit of the chain against the drive portion.

It is possible that the chain may slacken in use over time and this arrangement allows it to be tightened to optimise the drive action of the wheelchair. It has been found that this tightening arrangement provides reliable engaging of the chain with the sprocket wheel. This tensioning also assists in providing a smooth lever drive action.

The velocipede has a balancing device at the front, which is a wheel (820) in this embodiment but could take other forms such as a ball. Furthermore, the balancing device has a mechanism for steering the vehicle, which is described below. This steering device assists in the high degree of maneuverability of the vehicle and the velocipede could be provided with only one lever assembly. Only one drive lever assembly need be provided in the first embodiment if it also has a steering device, for example a central front wheel. The front wheel in the second embodiment has a pneumatic tyre (821).

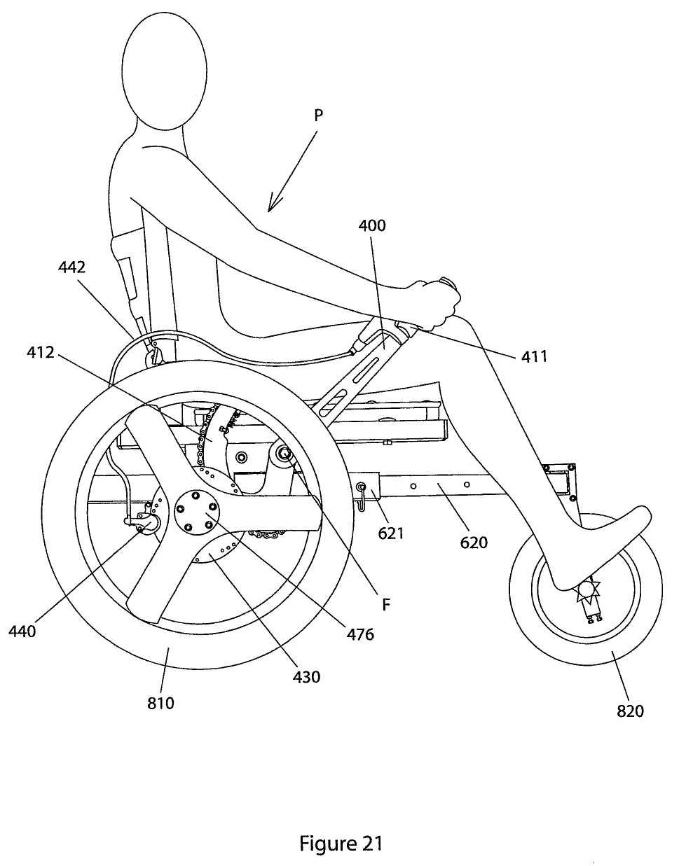

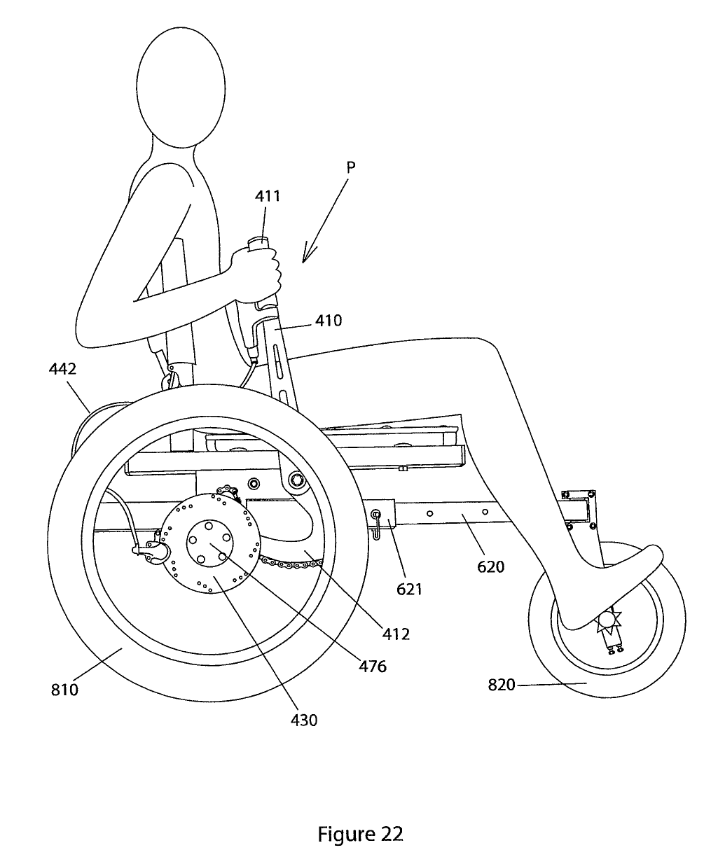

In FIG. 21, a person P is driving the velocipede, sitting with the trunk of their body supported on the seat (830) and their feet supported on the footrests (822) on the front wheel (820). The front wheel is pointing forwards so the vehicle is moving forwards. The person is raising the right-hand lever (400) (see also FIG. 30d which corresponds). FIG. 22 is similar, with the lever having been raised further and the lever is nearly at the end of its drive stroke (see also FIG. 30f which corresponds).

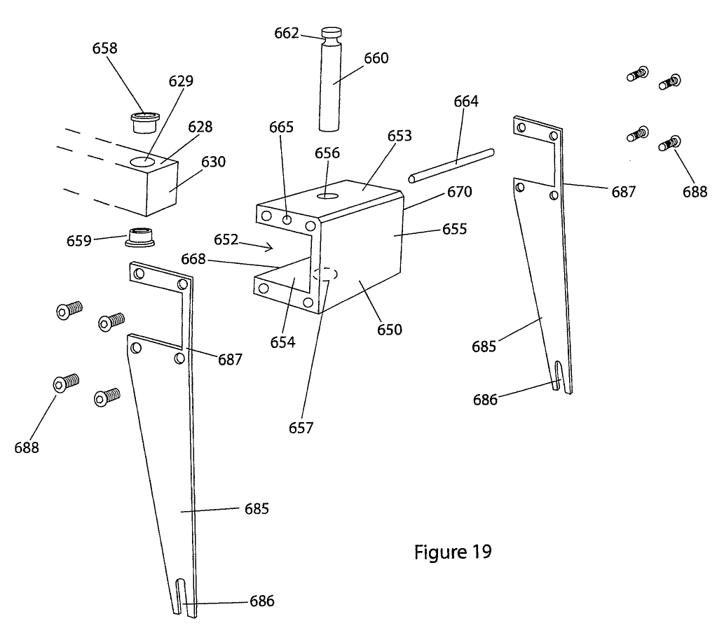

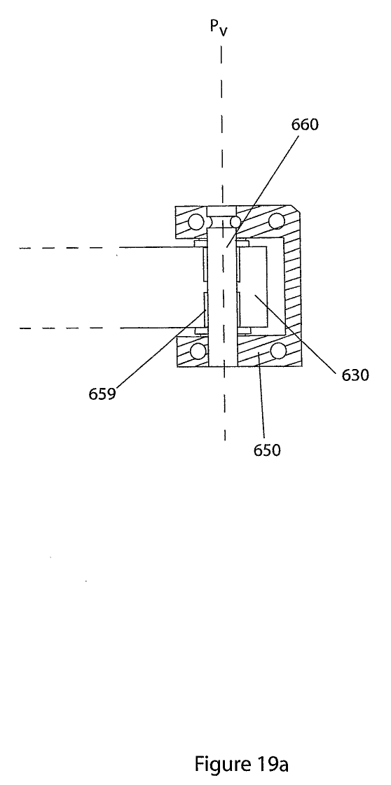

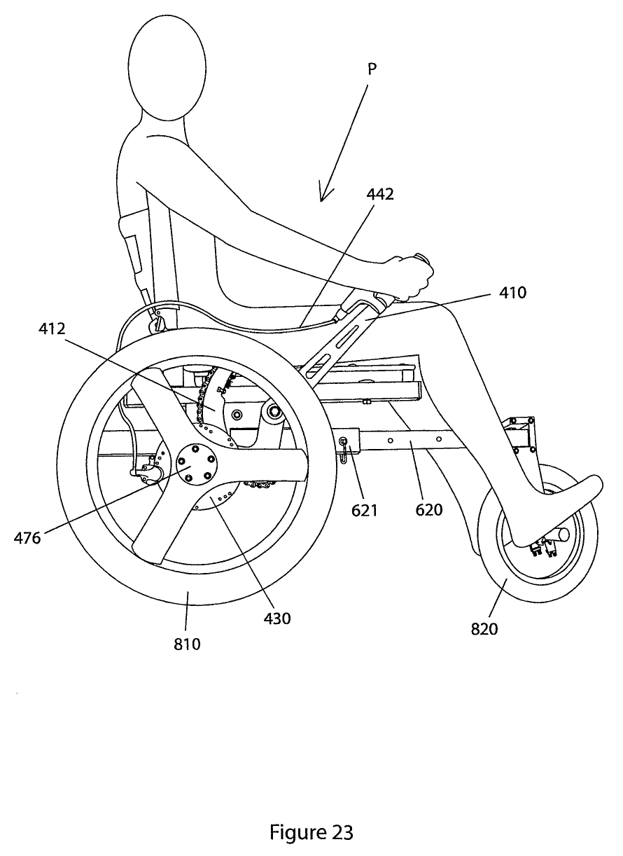

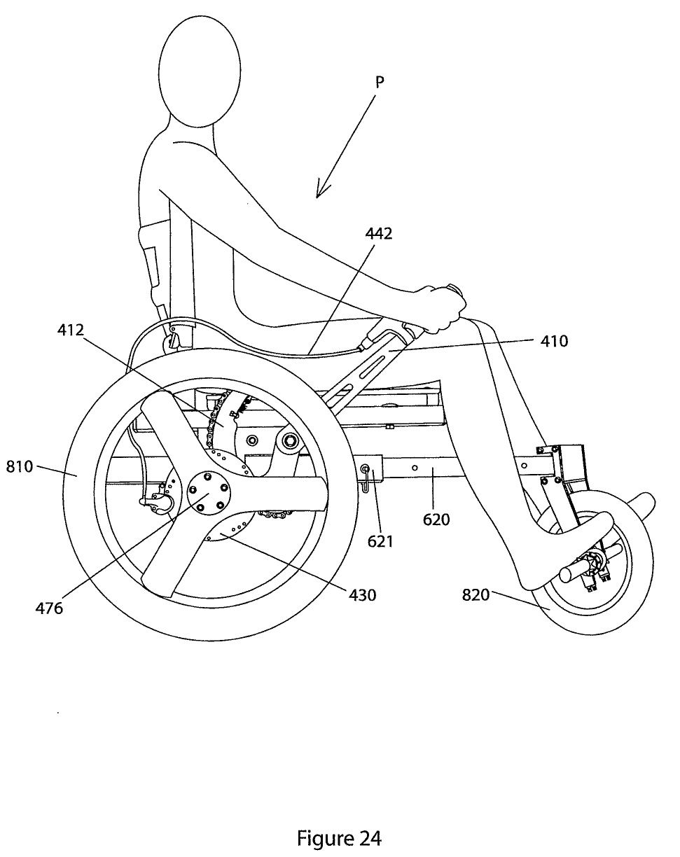

In FIG. 23, the person P has steered the velocipede to the left by turning the front wheel towards the left, using their feet on the footrests (822) to turn the wheel about its pivot P_{V} (see FIG. 19a). Similarly the velocipede can be steered to the right as shown in FIG. 24.

Referring to FIG. 15a, the shaft (620) is telescopic, having a fixed outer sleeve member (621), which is welded to the rest of the framework (840), in the space between upper and lower transverse members (844) and a slidable inner arm (622), which can be extended incrementally and locked in a desired position by a peg (623) placed through the desired one of a series of spaced holes (624) on the slidable arm and through a confronting hole on the outer sleeve member. The peg is held in place by a removable springy retainer (625) having a clip (626) located in a circumferential recess in the peg (623). Thus the length of the shaft can be adjusted so that the user is seated comfortably with their feet resting on footrests (822), one on each side of the front wheel of the velocipede.

The front wheel (820) is pivotally mounted on the extendable shaft (620) as follows.

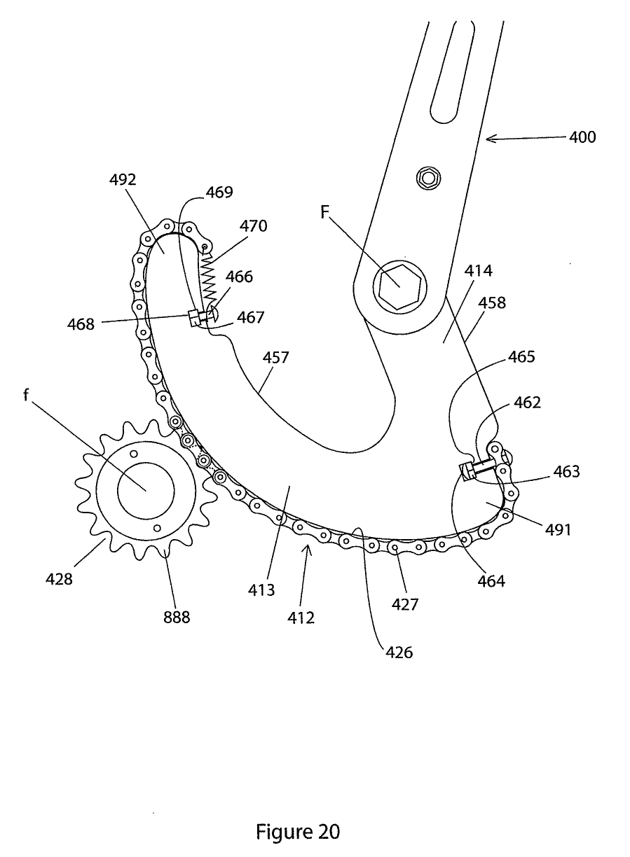

The outer anterior end (629) of the extendable arm (620) is mounted on a transverse support (650) for sideways pivotal movement on a vertical pin (655) about vertical pivot axis P_{V}, shown in FIG. 20a. The transverse support is a rigid, one-piece, extruded aluminium, C-shaped cross-member having an aperture (652) at one side for receiving the arm end (629), which has a square cross section. The C-shaped housing (650) has top and bottom planar horizontal walls (653, 654), joined by a vertical sidewall (655). Each plate has a central hole (656, 657) and these two holes are in correspondingly the same places so that they confront one another.

Referring to FIGS. 20 and 20a, the outer end (628) of the extendable arm (620) has a vertical, cylindrical, through-aperture (629) near its flat end face (630). The outer end (628) of the arm is located in the complementary side opening (652) of the housing (650), such that the end is engagingly held between the upper and lower walls (653, 654) with the vertical through-aperture aligned with the pair of holes (656, 67), with a nylon slide bearing (658, 659) above and below.

The vertical pin (660), made of stainless steel, extends through the vertical holes (656, 657) in the upper and lower walls (653, 654) of the housing as well as the vertical through-aperture (629) in the anterior end (630) of the arm. The vertical pivot pin has a circumferential recess (662) and is itself fixed by a cotter pin (664) disposed transversely in a horizontal elongate aperture (665) in the upper wall and in the side of the circumferential recess (662) perpendicularly to the vertical pivot pin (660) to lock it in place.

Extending downwards from each side end (668, 670) of the transverse housing (150) is a pair of 4 mm laser-cut, stainless steel, spaced, rigid side support forks (685). The forks are fixed at their lower ends (686) to each side end of the front wheel axle and at their upper ends (687) to each side of the housing by means of four small screws (688).

With this arrangement, the front wheel may be pivoted side-to-side as desired in order to steer the velocipede in the required direction. For example in FIG. 25, the user turns the front wheel to the left in order to travel leftwards and likewise in FIG. 26, the user turns the front wheel to the right in order to travel rightwards (from the point of view of the person looking forwards of the vehicle).

This velocipede is highly maneuverable and can travel over terrain having a variable gradient, for example curbs and bumpy ground.

This velocipede has various possible uses, for example as a mobility vehicle for disabled, elderly or infirm persons, a seated recreational vehicle or seated sports vehicle. In another form, the levers may be mounted at the sides of the vehicle such that they can be pushed down to move the vehicle forward; this might be suitable for disabled people without legs. In this case the lever pivot axis is disposed rearwardly of a vertical line through the wheel pivot axis.

It should also be noted that the rear wheels may be smaller than as shown and in such case the lever will be proportionally longer.

FIG. 28 is a flow chart summarising the steps of operating the at least one lever, as described above, for propelling the first and second embodiments of a user-propelled wheeled vehicle according to the invention.

These steps are as follows:

### Step 1

The occupant of the user-propelled wheeled vehicle turns one or both of the upper portions (110, 410) of the levers (100, 400) anti-clockwise, in the direction of arrow A, to turn the sprocket wheel (128, 428) in the direction of arrow C, to propel the vehicle forwards.

### Step 2

The occupant then turns the at least one upper portion (110, 410) of the levers (100, 400) clockwise and the vehicle freewheels forwards at the same time.

### Step 3

The occupant repeats steps 1 and 2 to travel forwards as far as required.

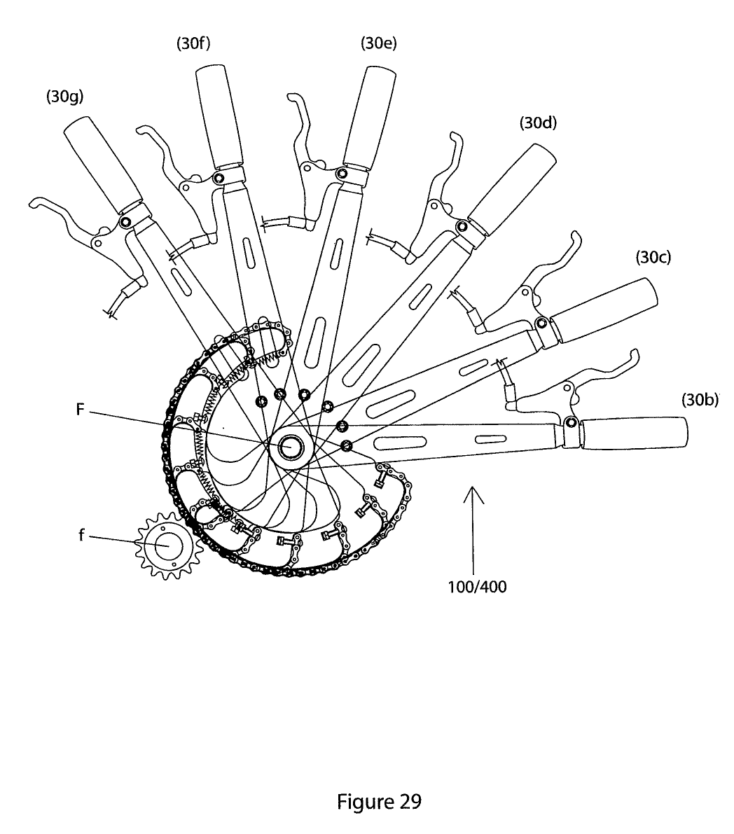

FIG. 29 is a composite view representing the sequence of anti-clockwise movement of the upper portion of the drive lever employed in the drive stroke of STEP 1 for both the first and second embodiments, from the beginning approximately horizontal position to the end approximately upright position, showing individual stages superposed to indicate relative positions of the or each lever with respect to the sprocket wheel on the driven wheel. In all views, the lever and the sprocket are the same and the sprocket wheel and the lever fulcrum are in the same respective positions.

FIGS. 30a to 30h show the stages of FIG. 29 individually.

As the upper portion of the drive lever is raised anti-clockwise about the fulcrum (F), the curved drive lower portion (113, 413) moves into engagement with the sprocket wheel (128, 428), co-axial with the respective side wheel. Then as the lever is continued to be turned as just described, the chain (127, 427) on the forward curved end (191, 491) of the drive portion (113, 413) is brought into meshing engagement with one and then two teeth at one side of the sprocket wheel. The chain meshes with the teeth in one quadrant (Q) i.e. one quarter of the circumference of the sprocket wheel. In the embodiments shown, with the lever fulcrum (F) forwards of the driven wheel fulcrum (f), the quadrant is the forward, upper quarter (Q) of the circumference of the sprocket wheel.

FIG. 30b shows the meshing of the drive chain with the teeth at the start of the drive stroke, with one roller between a pair of adjacent teeth. FIGS. 30c to 30g show the drive chain moving progressively over the teeth, two rollers involved, one each located in the two spaces between three adjacent teeth. As the drive chain progressively turns, it turns the sprocket wheel by engaging with successive teeth but always in the quadrant on the upper side of the sprocket wheel, disposed between the wheel fulcrum (f) and the lever fulcrum (F), as illustrated in these Figures.

At the end of the drive stroke, shown in FIG. 30g, similar to FIG. 30b, the rearward curved end (192, 492) of the drive portion (113, 413) starts to come off the teeth, engaging fewer teeth until the curved end of the drive portion is detached from the sprocket wheel.

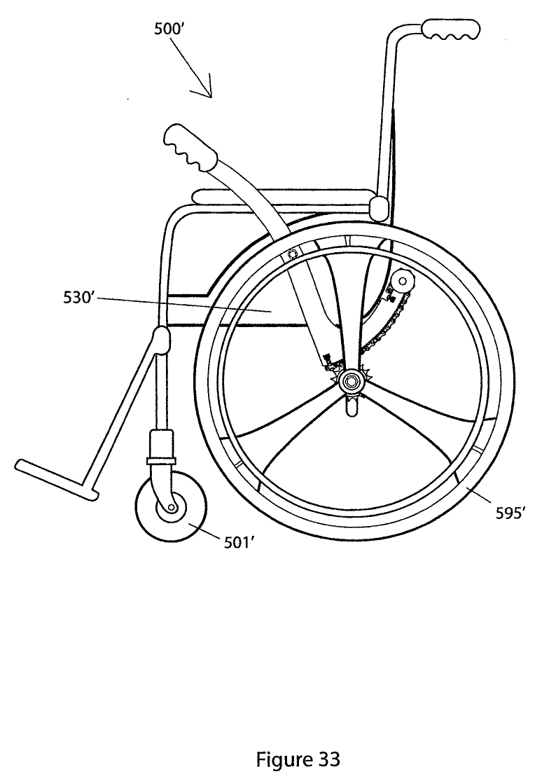

In a third embodiment, a wheelchair (500′), shown in FIGS. 31 to 33, is constructed and operated similarly to the earlier described wheelchair: in this embodiment unitary drive levers with curved upper arms are provided. The wheelchair (500′) has a chassis frame (501′) having a left side (530′) and a right side (532′) and a pair of relatively large, rear, left and right driven wheels (595′, 596′) and a pair of relatively small, front, non-driven wheels (501′) for balancing the vehicle. The wheelchair has a seat (520′) for the user and a forward end (599′) and a rearward end (599′). Each pair of wheels is symmetrically disposed about the longitudinal centre line through the wheelchair. The basic wheelchair is again of the type manufactured by Medicare under the Enigma range.

The wheelchair further includes a rigid arm lever (590′) on each side. The lever has a curved upper user-operable portion, with a handle (525′) and an arcuate, lower drive end (550′) (also referred to herein as a crank). The arcuate drive end has along its underside face (554′) a line of bicycle-type chain (556′), which is screw-fastened under tension.

The lower portions of the upper user-operable portions of the drive levers and the drive ends of the cranks of each lever arm are disposed between the respective wheel and the adjacent side (530′, 532′) of the vehicle. Each drive end meshes with a respective 7 cm diameter sprocket wheel (555′) co-axially mounted, inside the adjacent respective rear wheel (501′), on the hub of the respective wheel axle (560′). The sprocket wheel has an outer annular sprocket wheel (562′) with identical, regularly spaced teeth (561′) on a concentric inner annular wheel which houses an internal ratchet and pawl stop device to engage with the outer wheel. The stop device allows the outer wheel to only rotate in the forwards direction together with the inner wheel but the outer wheel may rotate rearwards without the inner wheel to allow the wheelchair to freewheel forwards. The wheelchair may be used conventionally in addition, to move rearwards and to adjust the angular disposition of the chair while in one location.

A brass single speed, freewheel gear of the type supplied by Lovson Exports Ltd under model no. LCS-110 can function as the sprocket wheel (555′). This is drivable forwards but allows the front wheel to rotate freely when not being driven forwards. The sprocket (555′) on the right of the wheelchair (looking forwards) is a right hand drive sprocket and the sprocket on the other side is a left hand version of the same sprocket.

Each lever arm is fixed to the side of the wheelchair for pivotal movement on a transverse pivot P^{L}. When the lever arm (590′) is pivoted rearwards by the person sitting in the wheelchair using their hands or arms to pull the arm levers backwards, the chain will interengage with the sprocket wheel to move it forwards, thereby propelling the scooter forwards. While the arm levers are pushed forwards, the wheelchair freewheels forwards, with there being no driving action. As a result the wheelchair travels forwards.

Alternatively, the rear wheels may be smaller than as shown and in this case, the lever is longer, so that the curved drive face reaches the sprocket on the wheel hub.

A similar arrangement for tightening as in the earlier embodiments, with a screw at each end of the roller chain for tensioning the chain and an additional tension spring at one end.

Finally the first, second and third aspects of the present invention may be embodied in other specific forms, for example having different dimensions, without departing from the spirit or essential characteristics thereof. In particular, for instance, the handle at the upper end of the user-operable elongate upper portion of the levers is optional.

Therefore, the above discussed embodiments of the first three aspects of the invention are considered to be illustrative and not restrictive, the scope of the invention being indicated by the respective claims.

An embodiment of a human-powered energy generator is now described.

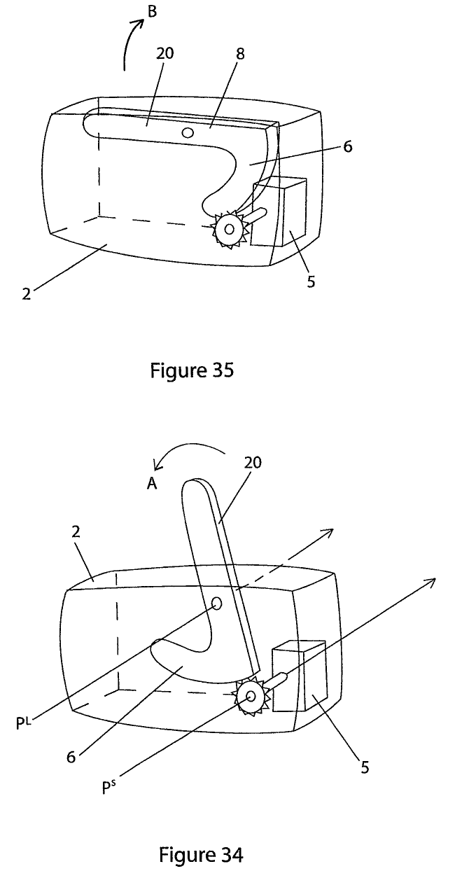

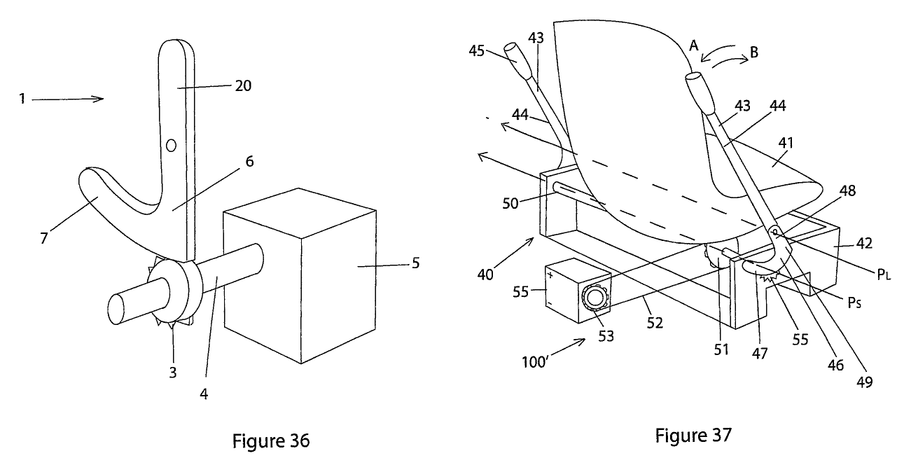

In this human-powered generator (100) for a portable electrical device, referring to FIGS. 34 to 36, a drive lever (1) is fixed for pivotal movement on the outside of a case (2) housing a radio (not shown).

The lever is disposed to mesh with a sprocket wheel (3), also disposed exteriorly of the casing on a transmission shaft (4), such that the sprocket is fastened to the shaft to drive the shaft, which itself is driving drivingly connected with an alternator (5), which is arranged inside the case to produce electricity to power the radio.

The drive lever (1) itself is pivotally mounted on the casing via a transverse pivot axis P^{L} by a fastening arrangement allowing a smooth pivotal action. The transmission shaft (4) is also disposed through the casing so as to be rotatable about a transverse pivot axis P^{S}, parallel to the lever transverse axis, so as to have a smooth pivotal action.

The drive lever and the shaft are both mounted in a stable and secure manner to assist in providing smooth and effective rotation of the transmission shaft, resulting in smooth and effective production of electricity for the radio (not shown).

The drive lever (1) has an upper user-operable portion (20) on the side above the pivot and a lower drive portion (6) on the side below the pivot. The drive portion has an arcuate drive end (7) joined to the pivot by an elongate member (8).

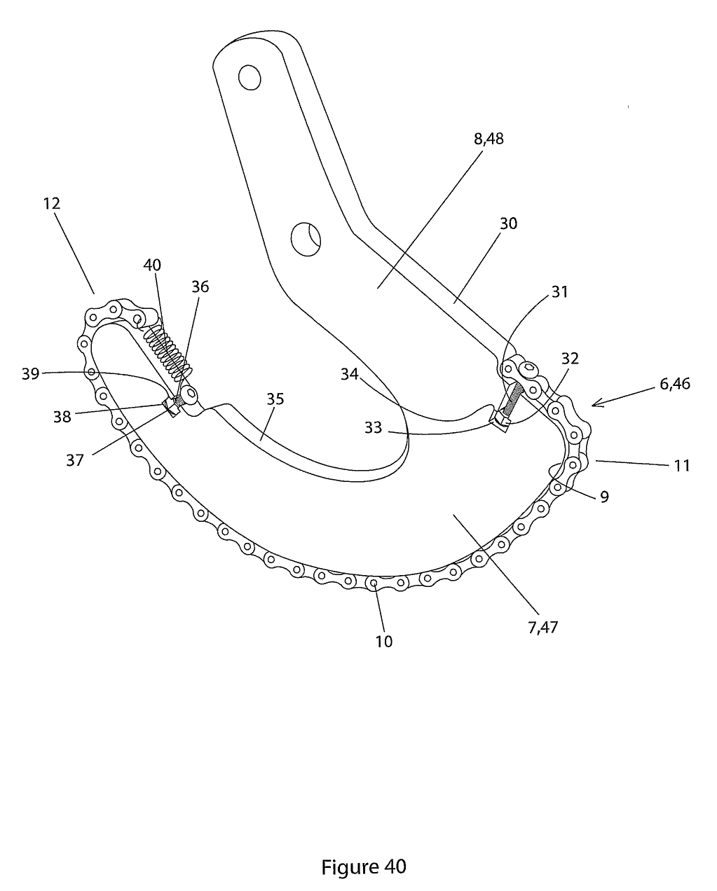

Referring to FIG. 40, the drive end has along its underside face (9) a length of bicycle-type roller chain (10) under tension, which consists of a series of regularly-spaced identical links and which is screw-fastened at each end under tension. The chain is ½″ pitch (width) roller chain, as supplied by Air Bearings Ltd. The chain passes around forward and rearward curved ends (11, 12) of the crank underside face. This tensioned chain further contributes to smooth and effective driving of the transmission shaft.

In use the sprocket is driven by the chain (10) on the drive end of the lever. The procedure will be described for the right-hand lever first. When the upper portion of the lever (110) is pulled back manually (in the anti-clockwise direction shown by arrow A in FIG. 34), by a user located next to the generator, the drive end will also move anti-clockwise and the chain (10) will engage with the sprocket wheel (3) to move it clockwise forwards, thereby propelling the transmission shaft clockwise. Repeated lever action directly on the sprocket (3) rotates the transmission shaft (4) clockwise.

The sprocket wheel (3) includes a one-direction mechanism so that the shaft (4) is moved in the same direction on each drive stroke of the drive lever. The one-direction mechanism has an outer annular sprocket wheel with identical, regularly spaced teeth on a concentric inner annular wheel which houses an internal ratchet and pawl stop device to engage with the outer wheel. The stop device allows the outer wheel to only rotate in the forwards direction together with the inner wheel but the outer wheel may rotate rearwards without the inner wheel while the lever is pushed forwards. Hence, after the anti-clockwise drive stroke, the drive lever is turned clockwise in a clockwise return stroke in the direction of arrow B shown in FIG. 35, to allow the lever to return to its initial extreme clockwise position (or an intermediate position if preferred). During the return stroke, the chain of the drive portion of the lever rolls over the sprocket wheel.

As shown in FIG. 40, the front end of the drive chain (10) is fastened, around the forward end of the drive member and up the front (30), by a screw (31) having a nut (32) at its non-head end. The nut is seated in an undercut recess (33) so that it acts against the upper face (34) of the recess, to allow adjustment of the screw to provide a desired fit of the chain against the drive portion. The chain is fastened, at its rear end, to the topside (35) of the arcuate drive portion by a smaller similar screw (36), nut (37) and undercut recess (38), with an upper face (39) against which the nut acts, but the end of the chain is connected to the screw via a sprung steel tension spring (40). The rear end may again be tightened (or slackened) to provide a desired fit of the chain against the drive portion.

It is possible that the chain may slacken in use over time and this arrangement allows it to be tightened to optimise the drive action of the lever. It has been found that this tightening arrangement provides reliable engaging of the chain with the sprocket wheel.

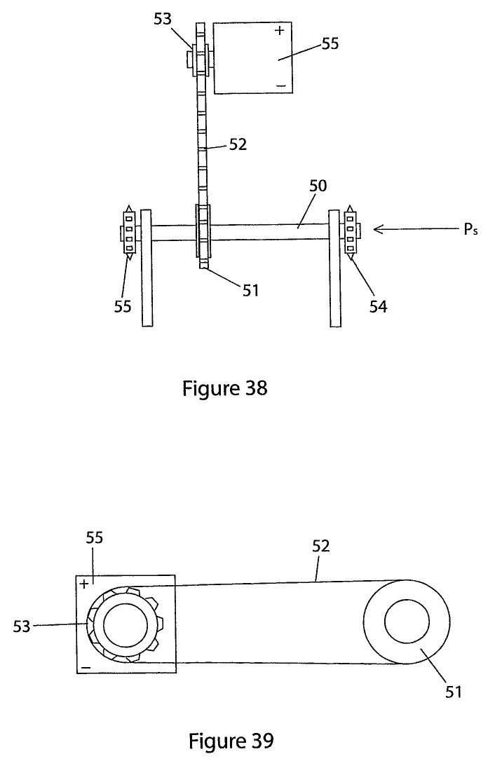

With reference to FIGS. 37 to 39 of the drawings, an embodiment of a generator including a user-support will now be described, in which a user may generate energy while seated, and the energy can be taken off and employed in an alternator to supply for example an electricity storage device (not shown). In this embodiment the generator employs a pair of spaced-apart drive levers according to the invention and as described above: the levers can be used to provide exercise for the user and at the same time generate energy.

This generator has a base frame (40) with a pair of spaced side walls (42), and acts as a stand. A drive lever assembly is attached to each side wall of the frame in a manner corresponding to the first embodiment. Thus, a drive lever (43), a driven freewheel sprocket or gearwheel (44), and transmission shaft (50) are provided. These are the same, and in correspondingly the same position, on both side walls of the stand. A chair (41) is attached to the frame for supporting a person who can act on the levers to supply human power to be converted into electrical energy.

Each lever (43) has an elongate user-operable upper portion (44) with a handle (45) conveniently at its upper end, and a remote, lower drive end portion (46), also referred to herein as a crank, which is rigidly connected with the user-operable elongate upper portion (44). The elongate upper portion and the drive member are rigidly connected by a bolt and nut fixing (not shown), for movement one with the other; alternatively they may be integral.

The lower drive end (46) has an arcuate drive member portion (47), which is attached to the upper portion (44) via an integral elongate radial connecting member (48). The arcuate drive member (47) and the radial connecting member (48) are joined via an enlarged strengthening region (49).

The user-operable elongate upper portions are approximately 40 cm long (from the pivot) and the radial member of the crank end is approximately 13 cm long; hence the ratio of the two approximately 3:1. This ratio gives good leverage.

The lever (43) itself is pivotally mounted on the frame via an arrangement allowing a smooth and effective pivotal action.

The right-hand and left-hand gear wheels (54, 55) are fixed to the transmission shaft (50) for pivotal movement about a transverse pivot axis P_{S}, through the shaft, which is parallel to a corresponding transverse axis P_{L} of the drive lever, the gearwheel pivot axis being located rearwards and downwards of the lever pivot axis. Thus, the lever pivot axis is spaced forwardly from a vertical line through the gearwheel pivot axis.

The design of the arcuate drive ends (46) of the levers and the freewheel gears (54, 55) are essentially the same as the arcuate drive end of the lever and the freewheel gear of the first embodiment as described earlier. The transmission shaft (50) is directly rotatable by the driven gearwheels. The lever assembly on the left-hand sidewall is identical to that on the right-hand side with the exception that the sprocket is an anti-clockwise sprocket, which again is driven forwards but anti-clockwise by the lever, in order that the gearwheels rotate the transmission shaft in the same direction.

A secondary transmission arrangement is provided to transfer the output energy from the transmission shaft to an alternator. This arrangement is in the form of an additional gearwheel (51) attached to the transmission shaft (50), now referred to as the primary transmission shaft. This gearwheel is drivingly connected via a transmission belt (52) to a driven gearwheel (53) on an alternator (55) for supplying energy thereto. Thus, the output is taken off at 90° and employed to rotate a shaft (not shown) drivingly connected in the alternator.

In use the sprocket is driven by the chain (10) on the drive end of the lever. Firstly considering the lever on the right-hand side of the chair (as viewed looking forwards from the chair) when the upper portion of the lever (44) is pulled back manually (in the anti-clockwise direction shown by arrow A in FIG. 34), by a user seated on the chair (41) located between the levers, the drive end will also move anti-clockwise and the chain (10) will engage with the right-hand sprocket wheel (3) to move it clockwise forwards, thereby also propelling the transmission shaft, as this is fastened for rotation therewith, clockwise. Repeated lever action directly on the sprocket (3) rotates the transmission shaft (4) clockwise.

The lever action is strong and reliable and also additionally assists in producing smooth and effective rotation of the gearwheels.

In summary, the arcuate crank drive ends move together with the upper drive portions about the horizontal pivot axis P_{L} and the drive portions are movable by the lever simultaneously therewith. Hence repeated lever action directly on the respective driven wheels propels the vehicle forwards and travel may be obtained. The levers may be used together or in turn, such as in a “Nordic skiing” style, which results in highly effective rotation of the transmission shaft.

After reaching the end of the drive stroke, the upper portion of each lever (44) is pushed forwards in a return stroke, with the chain of the drive portion of the lever rolling over the sprocket wheel; at the same time the respective driven gearwheel is allowed to freewheel forwards, with there being no driving action. As this is very quick, the drive stroke may start again very soon. If the Nordic style of driving is adopted, the gearwheels may be angularly moved in turn so that the transmission shaft is kept rotating at an approximately constant speed.

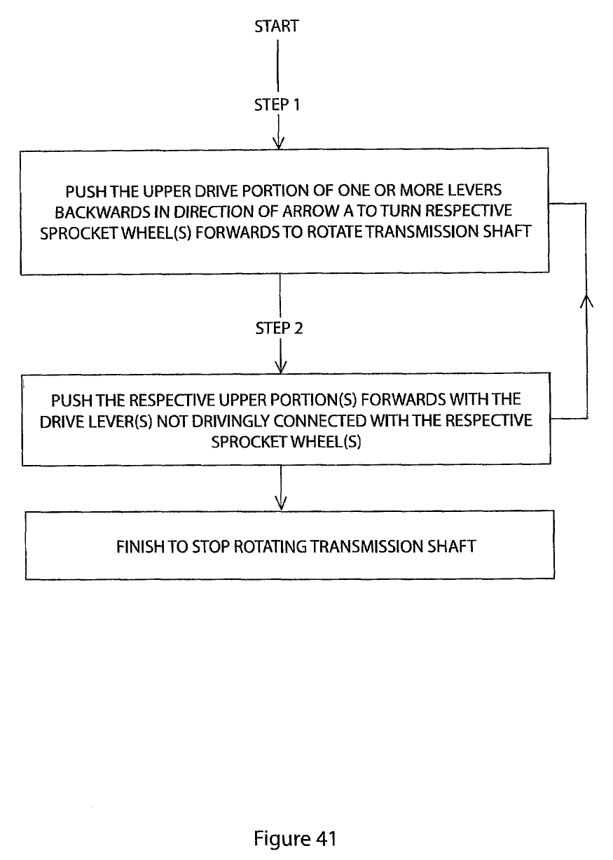

FIG. 41 is a flow chart summarising the steps of operating the at least one lever, as described for the embodiments of the fourth aspect of the invention above, for generating energy according to the invention.

These steps are as follows:

### Step 1

The user pushes at least one upper portion (20, 43) of one or more levers (1, 44) backwards in the direction of Arrow A (FIGS. 1 and 4). This turns the sprocket wheel(s) forwards, which rotates the transmission shaft.

### THEN

### Step 2

The user pushes the respective upper portion(s) forwards with the drive lever not drivingly connected with the respective sprocket wheel(s).

The user repeats steps 1 and 2 to rotate the transmission shaft to produce energy as required or finishes.

Thus, the drive levers can be moved by human power to directly act on associated gearwheels to drive a transmission shaft, the rotation of which can be employed to supply energy as required, for example to an alternator in which it is converted into electrical power for supplying a secondary device, such as a portable electrical device, or for storage for later use. The generator of the invention therefore harnesses renewable energy.

Finally the fourth aspect of the present invention may be embodied in other specific forms, for example having different dimensions, without departing from the spirit or essential characteristics thereof. In particular, for instance, the handle at the upper end of the user-operable elongate upper portion of the levers is optional.

Therefore, the presently discussed embodiments of the fourth aspect of the invention are considered to be illustrative and not restrictive, the scope of the invention being indicated by the respective claims.

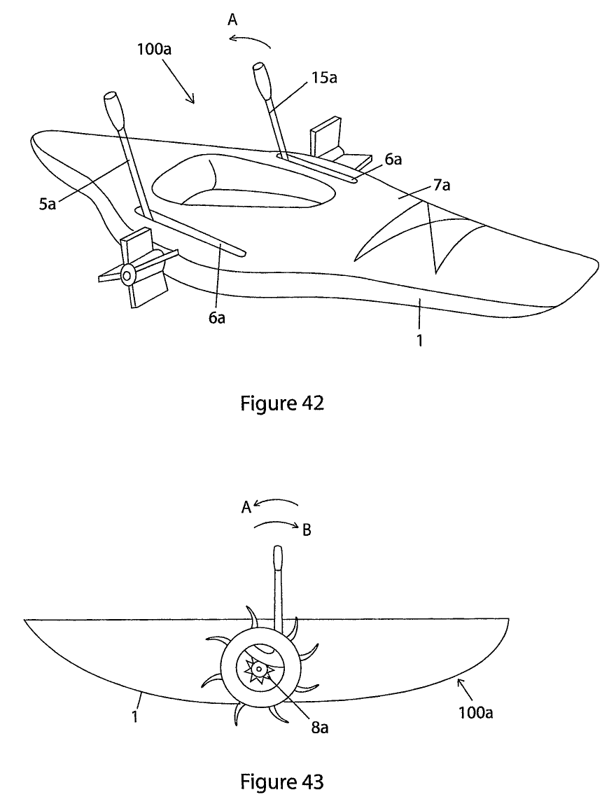

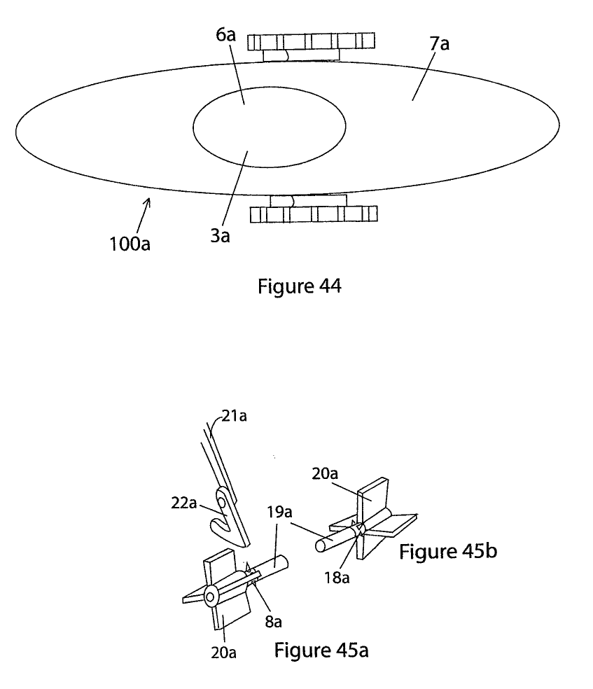

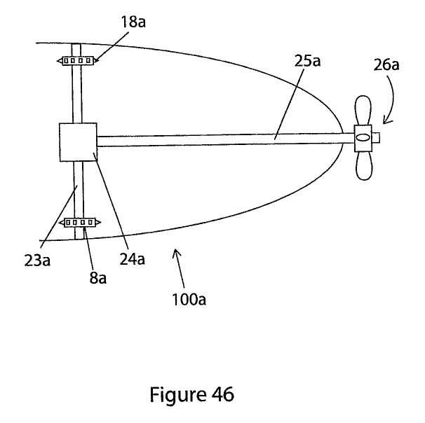

An embodiment of a human-powered watercraft according to the fifth aspect of the invention will now be described. A human-powered watercraft (100a), referring to FIGS. 42 to 46, is based on a kayak construction, having a body (1a) made from a hollow synthetic material. The craft has a seat (2a) provided by the floor of a recess (3a) in its upper surface (4a). A pair of drive levers (5, 15) is provided, one at each side of the seat (2a). Each lever is located for arcuate reciprocation i.e. to-and-fro pivotal movement in an elongate aperture (6a) in the upper surface (7a) of the craft body. Each lever is disposed to mesh with a sprocket or gearwheel (8a) on an axle (19a), one end of which is mounted inside the craft body for rotation and the other end of which is attached to a paddle (20a), which serves as a propulsion device. The levers are separately controlled so as to allow the craft to be steered in water.

Each drive lever is pivotally mounted on the craft body (1a) via a transverse pivot axis P^{L} by a fastening arrangement (not shown) allowing a smooth pivotal action. The axle (19a) is also disposed through the craft body so as to be rotatable about a transverse pivot axis P^{S}, parallel to the lever transverse axis, so as to have a smooth pivotal action.

The drive levers and the axles are both mounted in a stable and secure manner to assist in providing smooth and effective rotation of the axles, resulting in smooth and effective propulsion of the watercraft.

Each drive lever (5a, 15a) has an upper user-operable portion (21a) on the side above the pivot and a lower drive portion (22a) on the side below the pivot. The drive portion has an arcuate drive end (27a) joined to the pivot by an elongate member (28a).

A left-hand side drive lever assembly similar to the right-hand lever is mounted on the left-hand side of the craft in a manner corresponding to the mounting on the right-hand side. Thus, a drive lever (15a), a driven freewheel sprocket or gearwheel (8a), and an axle (19) are provided. These are in correspondingly the same position on both sides of the craft body. The lever assembly on the left-hand sidewall is identical to that on the right-hand side with the exception that the sprocket is an anti-clockwise sprocket, which again is driven forwards but anti-clockwise by the lever, in order that the gearwheels rotate the axles in the same direction. The procedure for the left-hand side lever is essentially the same, except the sprocket (18a) is anti-clockwise so that forward propulsion is still obtained by pulling back the lever.

The user-operable elongate upper portions are approximately 40 cm long (from the pivot) and the radial member of the lever end is approximately 13 cm long; hence the ratio of the two approximately 3:1. This ratio gives good leverage.

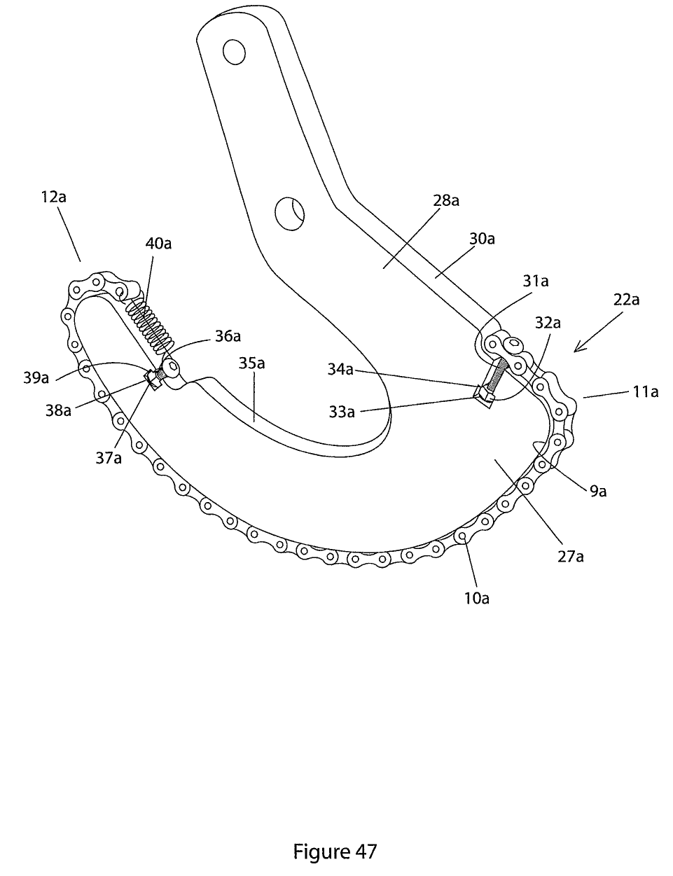

Referring to FIG. 47, the drive end (22a) of each lever (5a, 15a) has along its underside face (9a) a length of bicycle-type roller chain (10a) under tension, which consists of a series of regularly-spaced identical links and which is screw-fastened at each end under tension. The chain is ½″ pitch (width) roller chain, as supplied by Air Bearings Ltd. The chain passes around forward and rearward curved ends (11a, 12a) of the crank underside face. This tensioned chain further contributes to smooth and effective driving of the transmission shaft.

The sprocket wheels (8a, 18a) include a one-direction mechanism so that the axle (19a) is moved in the same direction on each drive stroke of the drive lever. The one-direction mechanism has an outer annular sprocket wheel with identical, regularly spaced teeth on a concentric inner annular wheel which houses an internal ratchet and pawl stop device to engage with the outer wheel. The stop device allows the outer wheel to only rotate in the forwards direction together with the inner wheel but the outer wheel may rotate rearwards without the inner wheel while the lever is pushed forwards. Hence, after the anti-clockwise drive stroke, the drive lever is turned clockwise in a clockwise return stroke in the direction of arrow B shown in FIG. 43, to allow the lever to return to its initial extreme clockwise position (or an intermediate position if preferred). During the return stroke, the chain of the drive portion of the lever rolls over the sprocket wheel.

As shown in FIG. 47, the front end of the drive chain (10a) is fastened, around the forward end of each drive member and up the front (30a), by a screw (31a) having a nut (32a) at its non-head end. The nut is seated in an undercut recess (33a) so that it acts against the upper face (34a) of the recess, to allow adjustment of the screw to provide a desired fit of the chain against the drive portion. The chain is fastened, at its rear end, to the topside (35a) of the arcuate drive portion by a smaller similar screw (36a), nut (37a) and undercut recess (38a), with an upper face (39a) against which the nut acts, but the end of the chain is connected to the screw via a sprung steel tension spring (40a). The rear end may again be tightened (or slackened) to provide a desired fit of the chain against the drive portion.

It is possible that the chain may slacken in use over time and this arrangement allows it to be tightened to optimise the drive action of the lever. It has been found that this tightening arrangement provides reliable engaging of the chain with the sprocket wheel.

In use the sprocket is driven by the chain (10a) on the drive end of each lever. The procedure will be described for the right-hand lever first. When the upper portion (21a) of the right-hand lever (5a) is pulled back manually (in the anti-clockwise direction shown by arrow A in FIGS. 42 and 43), by a user seated in the craft, the drive end (22a) will also move anti-clockwise and the chain (10a) will engage with the sprocket wheel (8a) to move it clockwise forwards, thereby propelling the transmission shaft clockwise. Repeated lever action directly on the sprocket (3a) rotates axle (19a) clockwise.

After reaching the end of the drive stroke, the upper portion (21a) of each lever is pushed forwards in a return stroke, with the chain of the drive portion of the lever rolling over the sprocket wheel; at the same time the respective driven gearwheel is allowed to freewheel forwards, with there being no driving action. As this is very quick, the drive stroke may start again very soon. The gearwheels (8a, 18a) may be angularly moved in turn so that the propulsion device(s) are kept rotating at an approximately constant speed.

The levers may be used together or in turn, such as in a “Nordic skiing” arm style, which results in highly effective rotation of the propulsion device(s).

In the second embodiment of watercraft, a pair of drive levers identical to the levers of the first embodiment is again employed.

The right-hand and left-hand gear wheels (8a, 18a) are both fixed to a transverse transmission shaft (23a) for pivotal movement about a transverse pivot axis P^{S} through the shaft, which is parallel to a corresponding transverse axis P^{L} of the drive lever, the gearwheel pivot axis being located rearwards and downwards of the lever pivot axis. Thus, the lever pivot axis is spaced forwardly from a vertical line through the gearwheel pivot axis.

The transmission shaft (23a) is directly rotatable by the driven gearwheels and a secondary transmission arrangement is provided to transfer the output energy to a propeller at the rear of the watercraft.

This arrangement is in the form of a gearbox (24a) attached to the transmission shaft (23a), now referred to as the primary transmission shaft. This gearbox is drivingly connected to a central secondary transmission shaft (25) at 90° to the primary shaft. Thus, the output is taken off at 90° and employed to rotate a single propeller (26a) centrally at the rear of the craft.

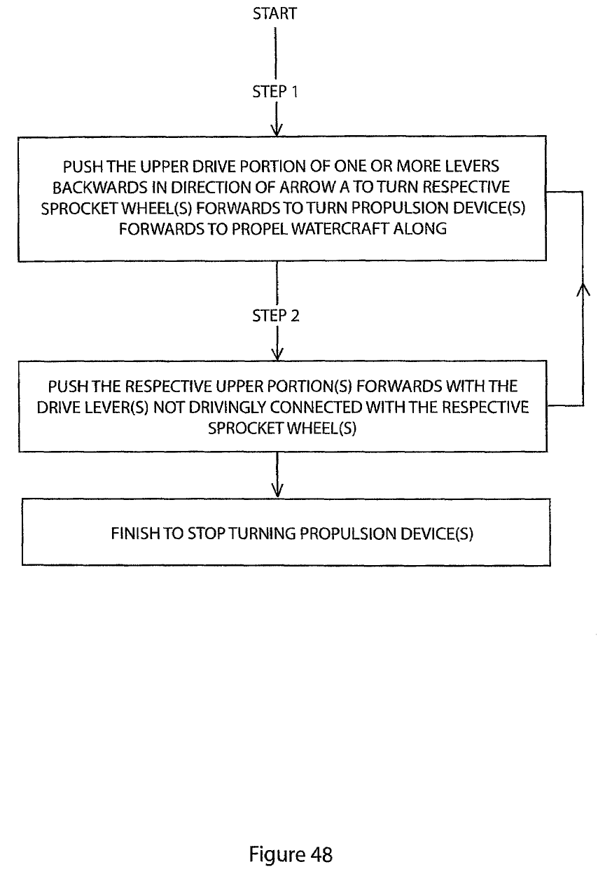

FIG. 48 is a flow chart giving the steps of operating the at least one lever, as described for the embodiments above, for propelling a watercraft according to the invention.

These steps are as follows:

### Step 1

The user pushes at least one upper portion (20, 43) of one or more levers (1, 44) backwards in the direction of Arrow A (FIGS. 1 and 4). This turns the sprocket wheel (s) forwards, which turns the axle(s) forwards, thereby turning the propulsion device(s) forwards and propelling the watercraft.

### THEN

### Step 2

The user pushes the respective upper portion(s) forwards with the drive lever not drivingly connected with the respective sprocket wheel(s).

The user repeats steps 1 and 2 to turn the propulsion device(s) forwards and propel the watercraft along.

Thus, the drive levers can be moved by human power to directly act on associated gearwheels to drive a propulsion mechanism for the watercraft. This not only harnesses renewable energy but also provides exercise for the user.

Finally the fifth aspect of the present invention may be embodied in other specific forms, for example having different dimensions, without departing from the spirit or essential characteristics thereof. In particular, for instance, the handle at the upper end of the user-operable elongate upper portion of the levers is optional.

Therefore, the presently discussed embodiments of watercraft are considered to be illustrative and not restrictive, the scope of the invention being indicated by the respective claims.

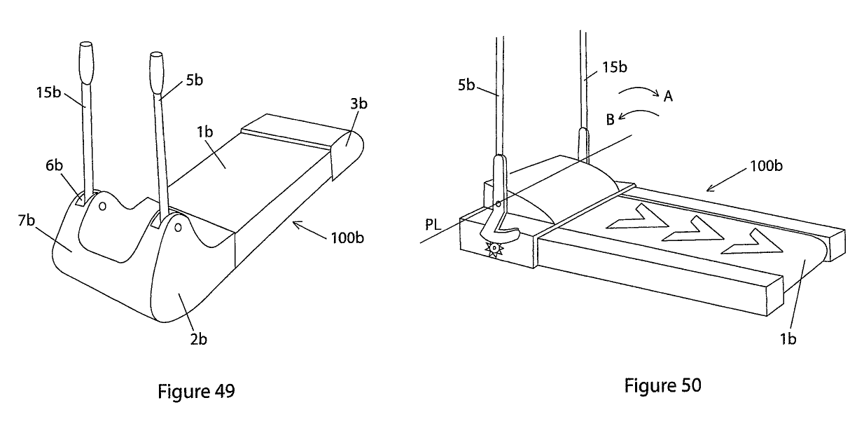

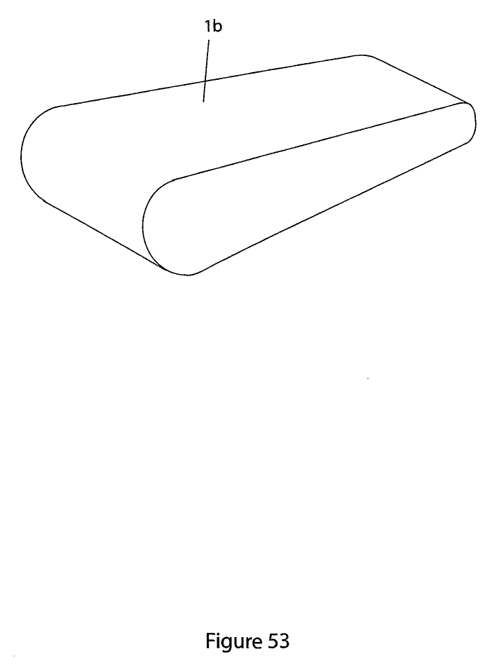

In an embodiment according to a sixth aspect of the invention a human-powered personal treadmill machine (100b), referring to FIGS. 49 to 53, is based on a conventional treadmill construction, having a supported endless belt (1b) and a conventional resistance device (not shown). In the FIG. 49 embodiment, the treadmill belt is supported, for operation, in a stationary housing (2b, 3b) at each of its front and back ends. The housing may rest on a flat support such as the ground or a platform. In the FIG. 50 embodiment the belt is supported, for operation, at its front end in a housing (2b) and at its sides in housings (4b).

With reference to the treadmill shown in FIG. 49, a pair of drive levers (5b, 15b) is provided, one at each side of the belt (1b). Each lever is located for arcuate reciprocation i.e. to-and-fro pivotal movement in an elongate aperture (6b) in the upper surface (7b) of the front housing. Each lever is disposed to mesh with a sprocket or gearwheel (8b) on the axle (19b) of a driven wheel (20b) on which the endless belt is mounted as shown in FIG. 52.

Each drive lever is pivotally mounted on the treadmill (100b) via a transverse pivot axis P^{L} by a fastening arrangement (not shown) allowing a smooth pivotal action. The axle (19b) is also disposed through the treadmill so as to be rotatable about a transverse pivot axis P^{S}, parallel to the lever transverse axis, so as to have a smooth pivotal action. The drive levers and the axles are both mounted in a stable and secure manner to assist in providing smooth and effective rotation of the axles, resulting in smooth and effective propulsion of the watercraft.

Each drive lever (5b, 15b) has an upper user-operable portion (21b) on the side above the pivot and a lower drive portion (22b) on the side below the pivot. The drive portion has an arcuate drive end (27b) joined to the pivot by an elongate member (28b).

A left-hand side drive lever assembly similar to the right-hand lever is mounted on the left-hand side of the machine in a manner corresponding to the mounting on the right-hand side. Thus, a drive lever (15b), a driven freewheel sprocket or gearwheel (8b), and an axle (19b) are provided. These are in correspondingly the same position on both sides of the treadmill. The lever assembly on the left-hand sidewall is identical to that on the right-hand side with the exception that the sprocket is an anti-clockwise sprocket, which again is driven forwards but anti-clockwise by the lever, in order that the gearwheels rotate the axles of the driven wheels in the same direction. The procedure for the left-hand side lever is essentially the same as for the right-hand sprocket, so that forward propulsion of the belt is still obtained by pulling back the lever.

The user-operable elongate upper portions are approximately 40 cm long (from the pivot) and the radial member of the lever end is approximately 13 cm long; hence the ratio of the two approximately 3:1. This ratio gives good leverage.

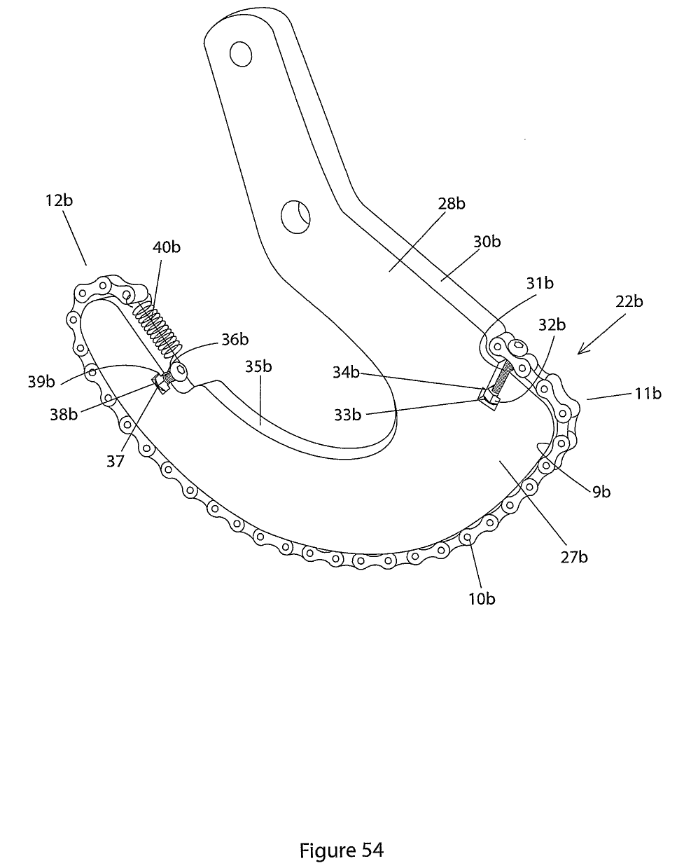

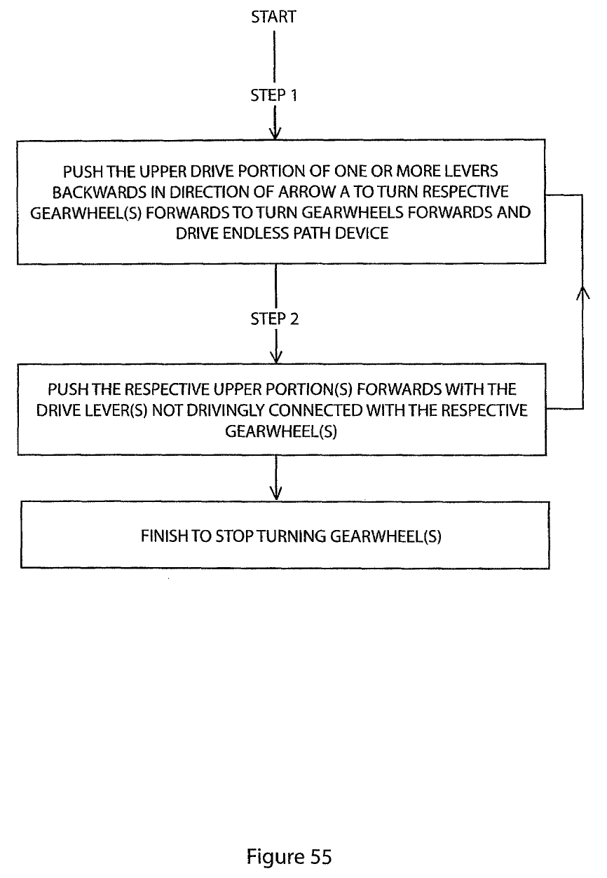

Referring to FIG. 54, the drive end (22b) of each lever (5b, 15b) has along its underside face (9b) a length of bicycle-type roller chain (10b) under tension, which consists of a series of regularly-spaced identical links and which is screw-fastened at each end under tension. The chain is ½″ pitch (width) roller chain, as supplied by Air Bearings Ltd. The chain passes around forward and rearward curved ends (11b, 12b) of the crank underside face. This tensioned chain further contributes to smooth and effective driving of the transmission shaft.

The sprocket wheels (8b) include a one-direction mechanism so that the axle (19b) is moved in the same direction on each drive stroke of the drive lever. The one-direction mechanism has an outer annular sprocket wheel with identical, regularly spaced teeth on a concentric inner annular wheel which houses an internal ratchet and pawl stop device to engage with the outer wheel. The stop device allows the outer wheel to only rotate in the forwards direction together with the inner wheel but the outer wheel may rotate rearwards without the inner wheel while the lever is pushed forwards. Hence, after the anti-clockwise drive stroke, the drive lever is turned clockwise in a clockwise return stroke in the direction of arrow B shown in FIG. 50, to allow the lever to return to its initial extreme clockwise position (or an intermediate position if preferred). During the return stroke, the chain of the drive portion of the lever rolls over the sprocket wheel.

As shown in FIG. 54, the front end of the drive chain (10b) is fastened, around the forward end of each drive member and up the front (30b), by a screw (31b) having a nut (32b) at its non-head end. The nut is seated in an undercut recess (33b) so that it acts against the upper face (34b) of the recess, to allow adjustment of the screw to provide a desired fit of the chain against the drive portion. The chain is fastened, at its rear end, to the topside (35b) of the arcuate drive portion by a smaller similar screw (36b), nut (37b) and undercut recess (38b), with an upper face (39b) against which the nut acts, but the end of the chain is connected to the screw via a sprung steel tension spring (40b). The rear end may again be tightened (or slackened) to provide a desired fit of the chain against the drive portion.

It is possible that the chain may slacken in use over time and this arrangement allows it to be tightened to optimise the drive action of the lever. It has been found that this tightening arrangement provides reliable engaging of the chain with the sprocket wheel.

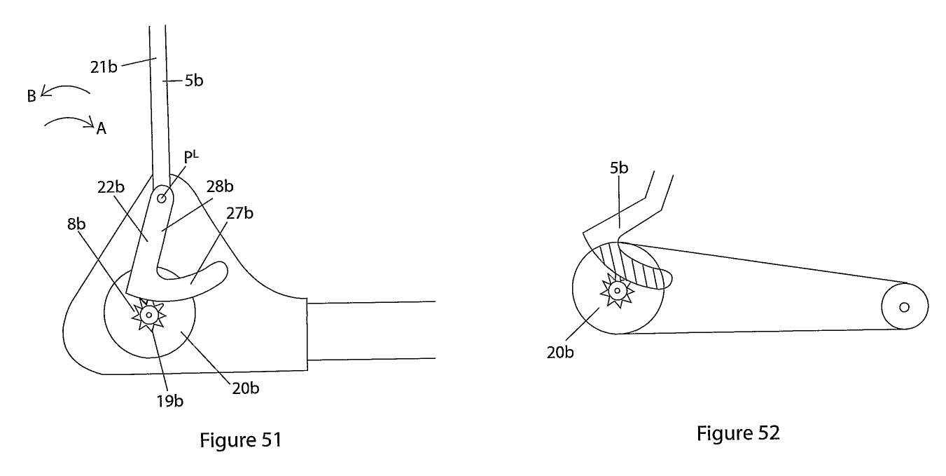

In use the sprocket is driven by the chain (10b) on the drive end of each lever. The procedure will be described for the right-hand lever first. When the upper portion (21b) of the right-hand lever (5b) is pulled back manually (in the anti-clockwise direction shown by arrow A in FIGS. 50 and 51), by a user supported on the treadmill, also move anti-clockwise and the chain (10b) will engage with the sprocket wheel (8b) to move it clockwise forwards, thereby propelling the transmission shaft clockwise. Repeated lever action directly on the sprocket (3b) rotates axle (19b) clockwise.

After reaching the end of the drive stroke, the upper portion (21b) of each lever is pushed forwards in a return stroke, with the chain of the drive portion of the lever rolling over the sprocket wheel; at the same time the respective driven gearwheel is allowed to freewheel forwards, with there being no driving action. As this is very quick, the drive stroke may start again very soon. The gearwheels (8b) may be angularly moved in turn so that the propulsion device(s) are kept rotating at an approximately constant speed.

The levers may be used together or in turn, such as in a “Nordic skiing” arm style, which results in highly effective rotation of the propulsion device(s).

In the second embodiment, a pair of drive levers identical to the levers of the first embodiment is again employed. The right-hand and left-hand gear wheels (8b) are both fixed to a transverse transmission shaft (23b) for pivotal movement about a transverse pivot axis P^{S} through the shaft, which is parallel to a corresponding transverse axis P^{L} of the drive lever, the gearwheel pivot axis being located rearwards and downwards of the lever pivot axis. Thus, the lever pivot axis is spaced forwardly from a vertical line through the gearwheel pivot axis. The transmission shaft is directly rotatable by the driven gearwheels so as to turn the endless belt (1b).

FIG. 7 is a flow chart giving the steps of operating the at least one lever, as described for the embodiments above, for operating a treadmill according to the sixth aspect of the invention.

These steps are as follows:

### Step 1

The user pushes at least one upper portion (21) of one or more levers (5, 15) backwards in the direction of Arrow A (FIGS. 50 and 51). This turns the sprocket wheel(s) forwards, which turns the axle(s) forwards, thereby turning the endless belt forwards and operating the treadmill.

### THEN

### Step 2

The user pushes the respective upper portion(s) forwards with the drive lever not drivingly connected with the respective sprocket wheel(s).

The user can repeat steps 1 and 2 to turn the endless belt forwards and operate the treadmill.

Thus, the drive levers can be moved by human power to directly act on associated gearwheels to drive endless path devices of stationary personal exercise machines. This not only harnesses renewable energy but also provides exercise for the user.

Finally the sixth aspect of the present invention may be embodied in other specific forms, for example having different dimensions, without departing from the spirit or essential characteristics thereof. In particular, for instance, the handle at the upper end of the user-operable elongate upper portion of the levers is optional.

Therefore, the presently discussed embodiments of the sixth aspect of the invention are considered to be illustrative and not restrictive, the scope of the invention being indicated by the respective claims.

1. A user-propelled wheeled vehicle having a seat for a user, comprising propelling apparatus comprising a driven wheel on each side of the vehicle and a device for driving each wheel, each drive device comprising a rigid lever, which is angularly movable about a transverse pivot axis at the side of the vehicle;
the lever having a user-operable portion on one side of the pivot axis and a drive end on the other side of the pivot axis, wherein the drive end is arcuately-reciprocatable with the user-operable portion and wherein the drive end includes a curved drive face, which includes a linear device for driving engagement with a sprocket wheel, which is co-axially mounted, between the wheel and the vehicle, on the hub of the wheel axle of the respective adjacent wheel, to drivingly co-operate with the respective vehicle wheel, to angularly move the wheel forwards and thereby to propel the vehicle forwards.

2. A user-propelled wheeled vehicle according to claim 1, wherein the sprocket wheel is a freewheel gear.

3. A user-propelled wheeled vehicle according to claim 1, further comprising a tensioning device at both ends of the linear engaging device to hold the linear engaging device and the driven wheel in sufficient co-operation for driving the wheel.

4. A user-propelled wheeled vehicle according to claim 3, wherein the tensioning devices are disposed so as to act in generally opposing directions.

5. A user-propelled wheeled vehicle according to claim 1, further including an additional tension spring at one end of the linear engaging device.

6. A user-propelled wheeled vehicle according to claim 1, wherein the linear engaging device is a length of bicycle-type chain.

7. A user-propelled wheeled vehicle according to claim 1, wherein the drive lever has a maximum angle of movement of approximately 90°.

8. A user-propelled wheeled vehicle having a support for a user, a wheel on each side of the vehicle, a device for steering the vehicle, and apparatus for driving at least one of the side wheels, the apparatus comprising a rigid lever, which is angularly movable about a pivot axis at the side of the vehicle,
the lever having a user-operable portion on one side of the pivot axis and a drive end on the other side of the pivot axis, wherein the drive end is arcuately-reciprocatable by the user-operable portion and includes a curved drive face, which includes a linear device for driving engagement with a device, which is co-axially mounted, between the wheel and the vehicle, on the hub of the wheel axle of the respective adjacent wheel, to angularly move the wheel forwards and thereby to propel the vehicle forwards.

9. A vehicle according to claim 8, wherein the lever has a pivot axis which is parallel with the pivot axis of the vehicle wheel.

10. A vehicle according to claim 8, wherein the lever pivot axis is disposed forwardly of the wheel pivot axis.

11. A vehicle according to claim 8, wherein the lever pivot axis is disposed upwardly of the wheel pivot axis.

12. A vehicle according to claim 8, wherein the co-axial device includes an arcuate circumferential portion for engaging with the drive face and the arcuate portion is disposed between the pivot axis of the lever and the pivot axis of the driven wheel.

13. A user-propelled wheeled vehicle according to claim 8, wherein the lower drive end further includes an integral radial member connecting the power drive end to the user-operable portion, the radial member inclined outwardly away from the upper portion.

14. A vehicle as claimed in claim 13, wherein the ratio of the length of the user-operable arm to the length of the radial member is approximately 3:1.

15. A user-propelled wheeled vehicle according to claim 13, wherein the drive lever has a maximum angle of movement of approximately 90′.

16. A user-propelled wheeled vehicle according to claim 15, wherein the drive lever has a maximum angle of movement of more than 90′.

17. (canceled)

18. (canceled)

19. A vehicle according to claim 8, including a balancing device forwardly of the side wheels, and further comprising a rigid transverse member receiving the outer end of the support shaft, wherein a pivot is provided by a device disposed through both the shaft and the rigid transverse member, for sideways steering of the vehicle, and further comprising a pair of spaced, rigid, side arms connecting:
firstly, at their lower ends, footrests, for steering, on the balancing device, with
secondly, at their upper ends, the rigid transverse member.

20-23. (canceled)

24. A vehicle according to claim 17, wherein the rigid transverse member includes a pair of spaced upper and lower walls and the outer end of the support shaft is held in the space therebetween, and the support shaft pivot device is disposed through the upper and lower walls as well as through the shaft therebetween.

25. A vehicle according to claim 17, wherein the rigid transverse member further comprises a vertical wall, disposed forwardly of the support shaft.

26. (canceled)

27. Drive lever apparatus for user-propelled wheeled vehicles having a support for a user and a wheel on each side of the vehicle, the apparatus comprising:
at least one drive lever device for driving a respective one of the side wheels, the at least one drive device comprising a rigid lever, which in use is angularly movable about a pivot axis at the side of the vehicle;
the lever having a user-operable portion on one side of the pivot axis and a drive end on the other side of the pivot axis, the drive end including a curved drive face, for drivingly co-operating with the respective vehicle wheel,
a device to be mounted co-axially on the respective driven wheel for angular movement therewith,
a linear device on the curved drive face of the drive lever, the co-axial device being capable of engaging with the linear device such that the linear device can drivingly engage the co-axial device, so as to turn the respective driven wheel of the vehicle.

28-67. (canceled)
